(19) United States
(12) Patent Application Publication
(10) Pub. No.: US 2018/0060788 A1
(43) Pub. Date: Mar. 1, 2018

(54) SYSTEM AND METHOD FOR ATTRIBUTE MATCHING

(71) Applicant: Beyrep, Glendale, CA (US)

(72) Inventor: Grace T. Mase, Glendale, CA (US)

(21) Appl. No.: 15/692,671

(22) Filed: Aug. 31, 2017

Related U.S. Application Data
(60) Provisional application No. 62/394,554, filed on Sep. 14, 2016.
(60) Provisional application No. 62/382,121, filed on Aug. 31, 2016.

(51) Int. Cl. G06Q 10/06; H04M 1/725; G06F 17/30

(52) U.S. Cl. CPC G06Q 10/063112; H04L 67/42; G06F 17/30867; H04M 1/72522

(57) ABSTRACT

A method and system for generating a selection alert are disclosed. The method includes receiving an input identifying a client user at a server, retrieving information related to a project for the client based on the input, and retrieving information related to a plurality of pro users based on the project information. The method also includes selecting one of the pro users from a pro user database, where the selection is based both on a professional characteristic parameter of the pro user and on a personal characteristic parameter of the pro user, generating a selection alert indicating the selection of the pro user, and sending the selection alert to the client user device from the server.

### CROSS-REFERENCES TO RELATED APPLICATIONS

This application claims the benefit of U.S. Provisional application No. 62/394,554, filed Sep. 14, 2016, titled “SYSTEM AND METHOD FOR ATTRIBUTE MATCHING,” and of U.S. Provisional application No. 62/382,121, filed Aug. 31, 2016, titled “SYSTEM AND METHOD FOR ATTRIBUTE MATCHING,” the disclosures of which are incorporated herein by reference.

### BACKGROUND OF THE INVENTION

Wireless communication is the transfer of information between two or more points that are not connected by an electrical conductor. The most common wireless technologies use radio waves. Wireless communication encompasses various types of fixed, mobile, and portable applications, including two-way radios, cellular telephones, personal digital assistants (PDAs), and wireless networking. Other examples of applications of radio wireless technology include GPS units, garage door openers, wireless computer mice, keyboards and headsets, headphones, radio receivers, satellite television, broadcast television and cordless telephones.

### BRIEF SUMMARY OF THE INVENTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system for generating a selection alert, the system including: a client user device. The system also includes a wireless communications interface configured to communicate through a cellular network or through wi-fi. The system also includes an input element configured to allow the client user to input information into the client user device. The system also includes an output element configured to provide the client user with information from the client user device; a pro user device including: The system also includes a wireless communications interface configured to communicate through a cellular network or through wi-fi. The system also includes an input element configured to allow the pro user to input information into the pro user device. The system also includes an output element configured to provide the pro user with information from the pro user device; and a server configured to: The system also includes receive an input identifying a client user. The system also includes retrieve information related to a project for the client based on the input. The system also includes retrieve information related to a plurality of pro users based on the project information. The system also includes select one of the pro users from a pro user database, where the selection is based both on a professional characteristic parameter of the pro user and on a personal characteristic parameter of the pro user. The system also includes generate a selection alert indicating the selection of the pro user. The system also includes send the selection alert to the client user device from the server. Other embodiments of this aspect include corresponding computer systems, apparatus, and computer programs recorded on one or more computer storage devices, each configured to perform the actions of the methods.

Implementations may include one or more of the following features. The system where the plurality of pro users have capabilities corresponding with the project. The system where the server is configured to calculate the professional characteristic parameter based on at least one of: capabilities of the pro user, charge of the pro user, and an expected of completion of the project for the pro user. The system where the server is configured to calculate the professional characteristic parameter based on one or more areas of specialty of the pro user. The system where the server is configured to calculate the professional characteristic parameter based on location or distance information of the pro user. The system where the server is configured to calculate the professional characteristic parameter based on one or more preferences of the client user. The system where the server is configured to calculate the personal characteristic parameter based on a result of a personality test. The system where the server is configured to calculate the personal characteristic parameter based on a characterization of the pro user as reported by other clients of the pro user. The system where the server is configured to calculate the personal characteristic parameter based on weighted aspects of the characterization, where the weighting of the aspects is determined based on preferences of the client user. The system where the server is configured to calculate the personal characteristic parameter based on a characterization of the client user as reported by other pros used by of the client user. The system where the server is configured to calculate the personal characteristic parameter based on weighted aspects of the characterization, where the weighting of the aspects is determined based on preferences of the pro user. The system where the server is configured to sort the pro users using a process which sorts first by the professional characteristic parameter and then sorts by the personal characteristic parameter. The system where the server is configured to select the one pro user based on its position in the sorted pro users. Implementations of the described techniques may include hardware, a method or process, or computer software on a computer-accessible medium.

One general aspect includes a method of generating a selection alert, the method including: receiving an input identifying a client user at a server; retrieving information related to a project for the client based on the input; retrieving information related to a plurality of pro users based on the project information; selecting one of the pro users from a pro user database, where the selection is based both on a professional characteristic parameter of the pro user and on a personal characteristic parameter of the pro user; generating a selection alert indicating the selection of the pro user; and sending the selection alert to the client user device from the server. Other embodiments of this aspect include corresponding computer systems, apparatus, and computer programs recorded on one or more computer storage devices, each configured to perform the actions of the methods.

Implementations may include one or more of the following features. The method further including calculating the professional characteristic parameter based on at least one of: capabilities of the pro user, charge of the pro user, and an expected of completion of the project for the pro user. The method further including calculating the professional characteristic parameter based on at least one of: an area of specialty of the pro user, location or distance information of the pro user, and one or more preferences of the client user. The method further including calculating the personal characteristic parameter based on at least one of: a characterization of the pro user as reported by other clients of the pro user, and a plurality of weighted aspects of the characterization, where the weighting of the aspects is determined based on preferences of the client user. The method further including calculating the personal characteristic parameter based on at least one of: a characterization of the client user as reported by other pros used by the client user, and a plurality of weighted aspects of the characterization, where the weighting of the aspects is determined based on preferences of the pro user. The method further including sorting the pro users using a process which sorts first by the professional characteristic parameter and then sorts by the personal characteristic parameter. The method further including selecting the one pro user based on its position in the sorted pro users. Implementations of the described techniques may include hardware, a method or process, or computer software on a computer-accessible medium.

### BRIEF DESCRIPTION OF THE DRAWINGS

FIG. 1 is a high-level block diagram of a system, in accordance with certain embodiments of the present disclosure.

FIGS. 2 and 2A-2C show diagrams of an architecture stack of the interaction infrastructure 102, in accordance with certain embodiments of the present disclosure, in accordance with certain embodiments of the present disclosure.

FIG. 3A is a block diagram of a system including one non-limiting example of a client device that corresponds to a mobile communication device, in accordance with certain embodiments of the present disclosure.

FIG. 3B depicts a high-level block diagram of a system for communication routing and tracking, in accordance with certain embodiments of the present disclosure.

FIG. 4 is a schematic depiction of one embodiment of databases in accordance with certain embodiments of the present disclosure.

FIG. 5 is a flowchart illustrating one embodiment of a process for generating and sending a selection alert.

FIG. 6 is a flowchart illustrating one embodiment of a process for intaking a user and entering information in a database.

FIG. 7 is a flowchart illustrating one embodiment of a process for selecting a next pro for a client.

FIG. 8 is a flowchart illustrating one embodiment of a process for selecting a next pro for a client.

### DETAILED DESCRIPTION OF THE INVENTION

Particular embodiments of the invention are illustrated herein in conjunction with the drawings.

Various details are set forth herein as they relate to certain embodiments. However, the invention can also be implemented in ways which are different from those described herein. Modifications can be made to the discussed embodiments by those skilled in the art without departing from the invention. Therefore, the invention is not limited to particular embodiments disclosed herein.

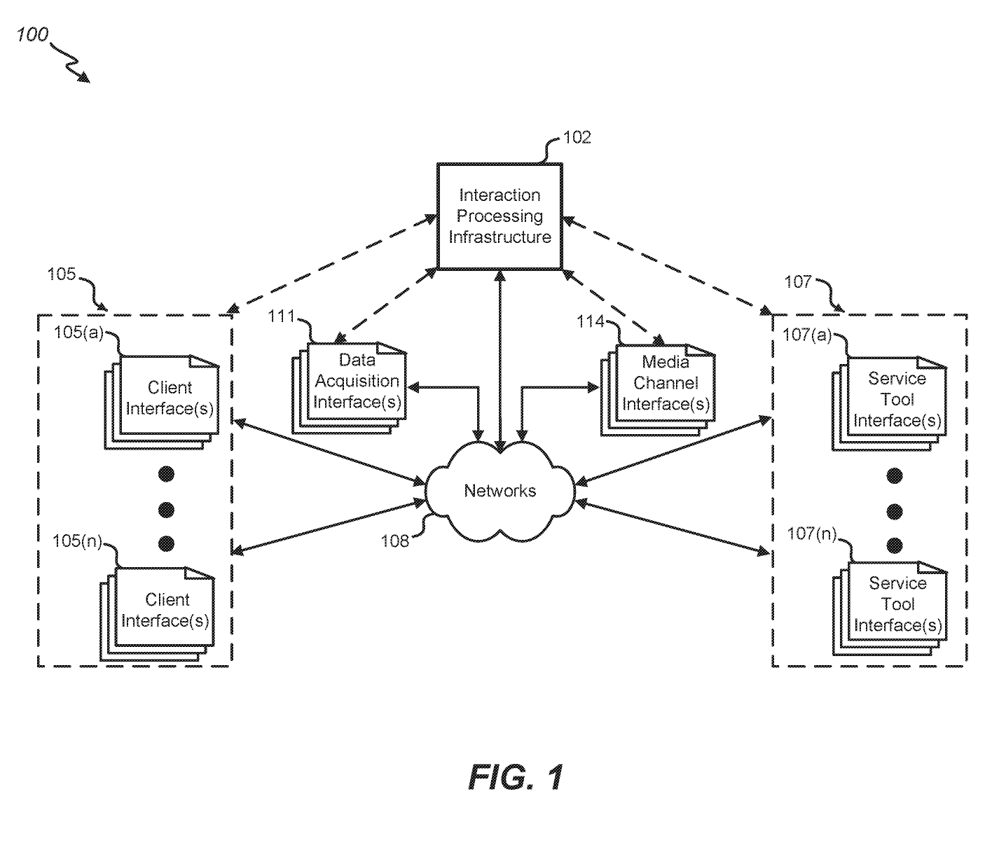

FIG. 1 depicts a high-level block diagram of a system 100, in accordance with certain embodiments of the present disclosure. The system 100 may allow for interaction between two or more of an interaction processing infrastructure 102 (sometimes referenced herein as interaction infrastructure 102), client interfaces 105, service tool interfaces 107, data acquisition interfaces 111, and/or media channel interfaces 114. As depicted, components of the system 100 may be communicatively coupled or couplable to one or more networks 108.

The one or more networks 108 may be a suitable means to facilitate data transfer in the system 100 and could include multiple networks and/or network components. In various embodiments, the one or more networks 108 may be implemented with, without limitation, one or more of the Internet, a wide area network (WAN), a local area network (LAN) such as one based on Ethernet, Token-Ring and/or the like, a wireless network (e.g., a network operating under Bluetooth®, any of the Institute of Electrical and Electronics (IEEE) 802.11 suite of protocols, and/or any other wireless protocol), a wireless local area network (WLAN), a cellular network, such as through 4G, 3G, GSM (Global System for Mobile Communications), etc., another wireless network, a gateway, a public switched telephone network (PSTN), and/or any other appropriate architecture or system that facilitates the communication of signals, data, and/or message. In various embodiments, the one or more networks 108 may transmit data using any suitable communication protocol(s), such as, without limitation, TCP/IP (transmission control protocol/Internet protocol), SNA (systems network architecture), IPX (Internet packet exchange), AppleTalk, and/or the like. In various embodiments, the one or more networks 108 and its various components may be implemented using hardware, software, and communications media such wires, optical fibers, microwaves, radio waves, and other electromagnetic and/or optical carriers; and/or any combination of the foregoing and/or the like. In some embodiments, the network 108 may include a telephone network that may be circuit switched, package switched, or partially circuit switched and partially package switched. For example, the telephone network may partially use the Internet to carry phone calls (e.g., through VoIP).

The interaction processing infrastructure 102 may facilitate searching of one or more information repositories in response to data received over the one or more networks 108 from any one or combination of the interfaces. In various embodiments, the interaction processing infrastructure 102 may include a set of devices configured to process, transform, encode, translate, send, receive, retrieve, detect, generate, compute, organize, categorize, qualify, store, display, present, handle, or use information and/or data suitable for the embodiments described herein. The interaction processing infrastructure 102 may be implemented in or with a distributed computing and/or cloud computing environment with a plurality of servers and cloud-implemented resources. The interaction processing infrastructure 102 may include processing resources communicatively coupled to storage media, random access memory (RAM), read-only memory (ROM), and/or other types of memory. The interaction processing infrastructure 102 may include various input and output (I/O) devices, network ports, and display devices.

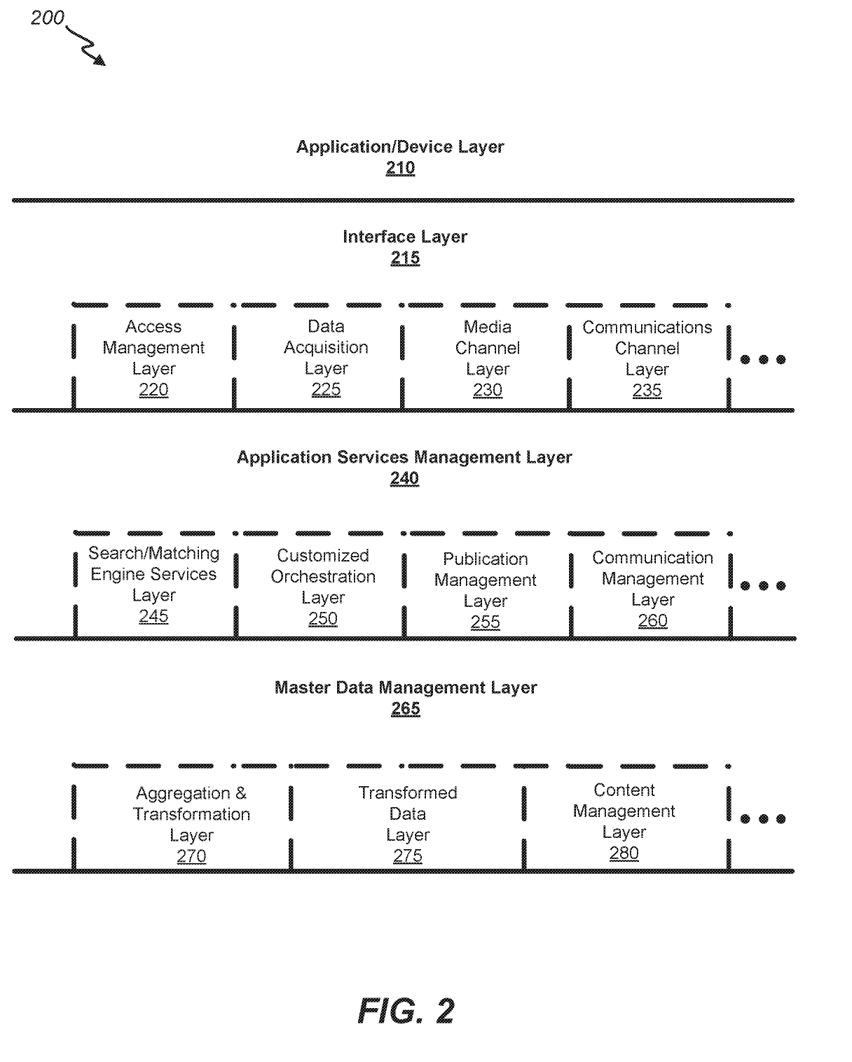

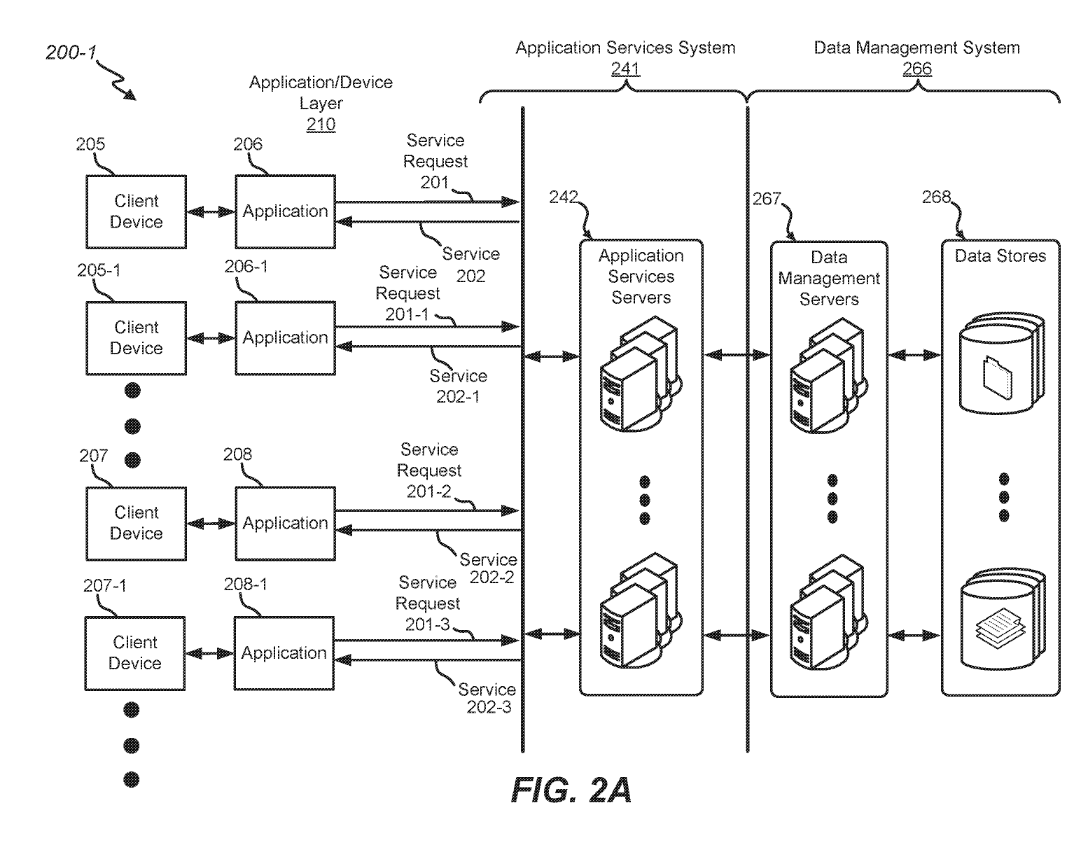

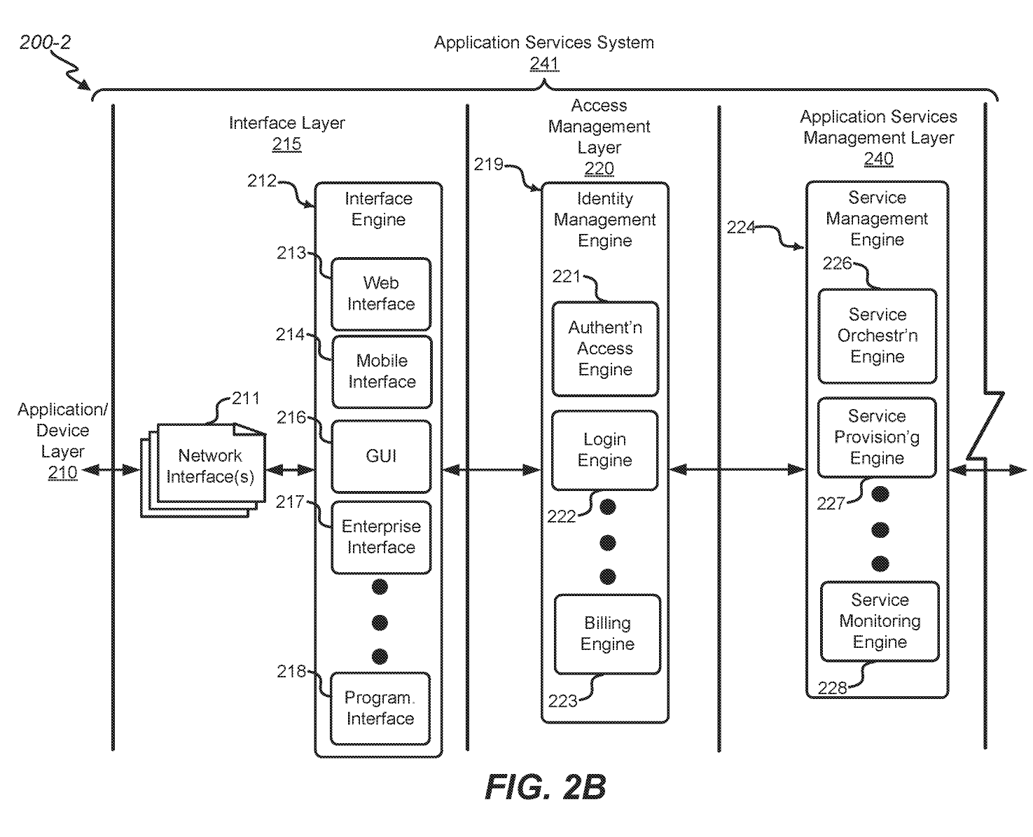

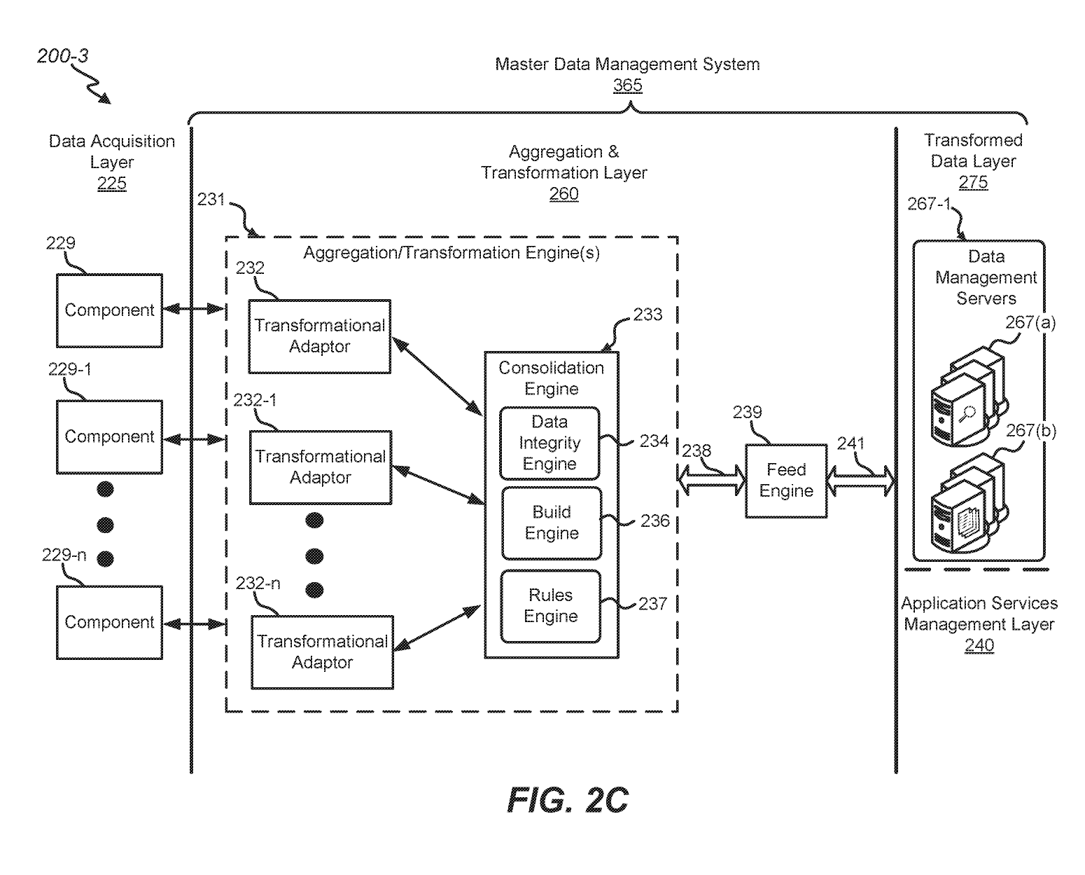

In certain embodiments, the interaction processing infrastructure 102 may be communicatively coupled or couplable to one or more data sources via one or more data acquisition interfaces 111. The one or more data sources may include any suitable source of data to facilitate embodiments disclosed further herein. In various embodiments, the one or more data sources may include one or more of a database, a website, any repository of data in any suitable form, and/or a third party system. In various embodiments, the one or more data sources may correspond to one or more social media websites and/or photo-sharing websites. With some embodiments, the data sources may include one or more mobile computing device locator services that provide information regarding the location of one or more client devices 205 and/or 207 (depicted in FIG. 2A). With some embodiments, the data sources may provide various details relating to call data. With some embodiments, the data sources may provide caller name information from calling name delivery (CNAM), also known as caller identification or caller ID, may be used to determine particular details about the caller. With some embodiments, the data sources may provide information about the area of a caller. With some embodiments, the data sources may provide demographic data about an area.

In various embodiments, the data from the one or more data sources may be retrieved and/or received by the interaction processing infrastructure 102 via the one or more data acquisition interfaces 111 through network(s) 108 and/or through any other suitable means of transferring data. In some embodiments, the interaction processing infrastructure 102 and the data sources could use any suitable means for direct communication. According to certain embodiments, data may be actively gathered and/or pulled from one or more data sources, for example, by accessing a third party repository and/or by “crawling” various repositories. Certain data pulled and/or pushed from the one or more data sources may be transformed and the transformed data and/or other data generated based thereon may be made available by the interaction processing infrastructure 102 for users of client devices 205 and/or 207. In some embodiments, the users can include one or several clients and/or one or several service providers, also referred to herein as pros. In some embodiments, these one or several service providers or pros can include, for example, a designer, an architect, an interior designer, an electrical engineer, a structural engineer, a mechanical engineer, a civil engineer, a builder, a general contractor, a trade contractor, a sub-contractor, or the like. In some embodiments, the client device(s) 205 can be client devices, and the client device(s) 207 can be provider devices. In alternative embodiments, data from the one or more data sources may be made available directly to client devices 205 and/or 207.

In some embodiments, the one or more data acquisition interfaces 111 may be implemented in similar manner to interfaces 105 and/or 107 or any other suitable interface. In some embodiments, the one or more data acquisition interfaces 111 may include one or more application programming interfaces (APIs) that define protocols and routines for interfacing with the data sources. The APIs may specify application programming interface (API) calls to/from data source systems. In some embodiments, the APIs may include a plug-in to integrate with an application of a data source system. The one or more data acquisition interfaces 111, in some embodiments, could use a number of API translation data sets configured to allow interface with the one or more additional applications of the data sources to access data (e.g., a database or other data store) of the data sources. The API translation data sets may translate the protocols and routines of the data source system to integrate at least temporarily with the system and allow communication with the system by way of API calls. Data, as referenced herein, may correspond to any one or combination of raw data, unstructured data, structured data, information, and/or content which may include media content, text, documents, files, instructions, code, executable files, images, video, audio, and/or any other suitable content suitable for embodiments of the present disclosure.

According to certain embodiments, the interaction processing infrastructure 102 may include or provide a service management platform. A provider may access the interaction processing infrastructure 102 via a service tool interface 107. An end user may access the interaction processing infrastructure 102 via a client interface 105. The interaction processing infrastructure 102 may facilitate searching of one or more information repositories in response to information received over the network 108 from the client interfaces 105 and/or service tool interfaces 107.

The client interfaces 105 and/or service tool interfaces 107 may allow for transfer of and access to information in accordance with certain embodiments disclosed herein. In various embodiments, the client interface(s) 105 and/or service tool interface(s) 107 may include one or more suitable input/output modules and/or other system/devices operable to serve as an interface between a service provider(s) and the provider management platform. The client interfaces 105 and/or service tool interfaces 107 may facilitate communication over the network 108 using any suitable transmission protocol and/or standard. In various embodiments, the interaction infrastructure 102 may include, provide, and/or be configured for operation with the client interfaces 105 and/or service tool interfaces 107, for example, by making available and/or communicating with one or more of a website, a web page, a web portal, a web application, a mobile application, enterprise software, and/or any suitable application software. In some embodiments, a client interface 105 and/or service tool interface 107 may include an API to interact with the interaction infrastructure 102.

In some embodiments, a client interface 105 and/or a service tool interface 107 may include a web interface. In some embodiments, the client interface 105 and/or service tool interface 107 may include or work with an application made available to one or more interfaces, such as a mobile application as discussed herein. In some embodiments, the client interface 105 and/or service tool interface 107 may cause a web page to be displayed on a browser of a service provider. The web page(s) may display output and receive input from a user (e.g., by using Web-based forms, via hyperlinks, electronic buttons, etc.). A variety of techniques can be used to create the web pages and/or display/receive information, such as JavaScript, Java applications or applets, dynamic HTML and/or AJAX technologies. Accordingly, the interaction processing infrastructure 102 may have web site(s)/portal(s) giving access to such information, such as a provider portal.

In various embodiments, a client interface 105 and/or a service tool interface 107 may include providing one or more display screen images that may each include one or more user interface elements. A user interface may include any text, image, and/or device that can be displayed on a display screen for providing information to a user and/or for receiving user input. A user interface may include one or more widgets, windows, dashboards, text, text boxes, text fields, tables, grids, charts, hyperlinks, buttons, lists, combo boxes, checkboxes, radio buttons, and/or the like.

In certain embodiments, a client interface 105 and/or a service tool interface 107 may include a computing device of an end user and/or a service provider. In certain embodiments, a client interface 105 and/or a service tool interface 107 may include a mobile computing device that may be any portable device suitable for sending and receiving information over a network in accordance with embodiments described herein.

Certain embodiments may provide a multi-channel communication regime to coordinate multiple communication channels used by end users and providers. Multiple communication pipes within a communication pipe could be implemented according to certain embodiments. Some embodiments may implement a greater number of communication channels. For example, one set of channels could be used for an end user to request help, and one set of channels could be used for a provider to respond to the end user. The system can use web communication, text communication, voice communication, e-mail communication, push notification, and/or the like.

According to certain embodiments, the interaction processing infrastructure 102 may be or include a content provisioning platform. In some embodiments, the interaction processing infrastructure 102 may provide for the selection, generation, and provision of content objects to one or more client interfaces 105. In certain embodiments, providers may have content objects that may be placed in a web page made available to one or more client interfaces 105. In certain embodiments, providers may have content objects that may be displayed with an application made available to one or more client interfaces 105, such as a mobile application according to various embodiments. In some embodiments, placement of the content objects could be in accordance with one or more paid placement arrangements and one or more content presentation models.

Content objects may be included in a results page responsive to a keyword search initiated by an end user via, for example, a webpage and/or a mobile application. The search may be performed by an online search engine facilitated by the interaction processing infrastructure 102. A content object of provider may be included within a results page with results identified and/or compiled by the search engine and sent via the network 108 to the client interface 105 of the end user that initiated the search.

An end user, in various embodiments, may correspond to an end user of products, services, and/or information. A provider, in various embodiments, may correspond to (and may be variously referenced herein by) any one or combination of a service provider, a product provider, a merchant, a commercial entity (“entity”), an advisor, a representative, and/or the like. End users may use one or more client interfaces 105; providers may use one or more service tool interfaces 107.

FIG. 2 shows a diagram of an architecture stack 200 of the interaction infrastructure 102, in accordance with certain embodiments of the present disclosure. While architecture stack 200 is illustrated as having a particular structure, it should be understood that certain embodiments may include other structures, including those with more or less layers than illustrated, in varying orientations and divisions. The architecture stack 200 may be implemented across a plurality of systems and/or subsystems corresponding to the interaction infrastructure 102. In some embodiments, a multi-layer part of the architecture stack 200 may be implemented at a single system or device within the interaction infrastructure 102.

The different layers of the architecture stack 200 are described generally herein with reference to FIG. 2 and in detail with reference to subsequent figures. From a high level perspective, the architecture stack 200 may include an application and/or device layer 210, an application services management layer 240, and/or a master data management layer 265. The application and/or device layer 210, the application services management layer 240, and/or the master data management layer 265 may include or otherwise interface with any of various sublayers. In some embodiments, the application and/or device layer 210, the application services management layer 240, and/or the master data management layer 265 may share resources and services with any one or combination of sublayers; and, in some embodiments, certain sublayers may share resources and services with certain other sublayers.

The application/device layer 210 may include user devices and applications for interacting with the other elements of the architecture stack 200 via the elements of an interface layer 215. For example, the applications may include web-based applications, entity portals, mobile applications, widgets, and the like for requesting services from and/or otherwise accessing the interaction infrastructure 102. These applications may run on one or more user devices. The user devices may be any suitable user device as detailed herein.

The interface layer 215 of the architecture stack 200 may provide interfaces for a user device to interact with the other elements of the architecture stack 200. For example, clients, entities, administrators, and others serviced by and/or otherwise associated with the interaction infrastructure 102 may utilize one or more user devices interacting within the application/device layer 210 to request services and/or access from an application services management layer 240. In some examples, a web-based search interface, a mobile application search interface, an orchestration platform interface, a provider dashboard interface, and/or the like may be provided.

In various embodiments, the interface layer 215 may include or otherwise interface with any one or combination of an access management layer 220, a data acquisition layer 225, a media channel layer 220, a communications channel layer 235, and/or the like layer in accordance with embodiments disclosed herein.

The architecture stack 200 may include an access management layer 220. The access management layer 220 may include elements to manage access to services and/or data. For example, the access management layer 220 may include elements to verify user login credentials, IP addresses associated with a user device, device IDs, telephone numbers, locations, and/or the like in order to provide certain services and/or access.

The architecture stack 200 may include a data acquisition layer 225. In some embodiments, the data acquisition layer 225 may be included in the application services management layer 240. The data acquisition layer 225 may receive data from various data sources to facilitate various embodiments disclosed herein. The any one or combination of data sources disclosed herein and/or the like, with aggregation being facilitated in some embodiments with any one or combination of interfaces 105, 107, 111, 114 and/or client devices 205, 207.

The architecture stack 200 may include a media channel layer 220. The media channel layer 220 may provide interfaces for the interaction infrastructure 102 to utilize various media channels. For example, services may be provided to clients, entities, administrators, and others serviced by and/or otherwise associated with the interaction infrastructure 102 by way of media channels of many various types including websites, mobile applications, social/business network websites, cable and satellite television, telephone systems, video distribution, and print (e.g., newspapers and magazines).

The architecture stack 200 may include a communications channel layer 235. The communications channel layer 235 may provide interfaces for the interaction infrastructure 102 to centrally manage services based on real-time communications. For example, services may be provided to clients, entities, administrators, and others serviced by and/or otherwise associated with the interaction infrastructure 102 by way of tracking and/or handling of communications such as telephone calls, video calls, messages, chats, video conferencing, and/or the like in response to content objects presented through the various media channels.

In various embodiments, the application services management layer 240 may include or otherwise interface with any one or combination of a search/matching engine services layer 245, a customized orchestration layer 250, a publication management layer 255, a communications management layer 260, and/or the like layer in accordance with embodiments disclosed herein. In various embodiments, the search/matching engine services layer 245 may include elements to provide effective search and/or matching services to end users, providers, and/or internal elements and/or users of the interaction infrastructure 102. In some embodiments, the search and/or matching services may include geo-aware search and/or matching services. The geo-aware search and/or matching services may provide fast and efficient access to information tailored to particular geographies. In various embodiments, the master data management layer 265 may include or otherwise interface with any one or combination of an aggregation and transformation layer 270, a transformed data layer 275, a content management layer 280, and/or the like layer in accordance with embodiments disclosed herein.

FIG. 2A shows a diagram of a portion 200-1 of the architecture stack 200 of the interaction infrastructure 102, in accordance with certain embodiments of the present disclosure. The portion 200-1 at least partially includes the application/device layer 210, as wells as an application services system 241 and a data management system 266 of the interaction infrastructure 102. In some embodiments, the application services system 241 may correspond at least partially to the interface layer 215 and the application services management layer 240. In some embodiments, the data management system 266 may correspond at least partially to the master data management layer 265.

The application services system 241 may interface with the application/device layer 210 and the data management system 266. In some embodiments, the application services system 241 may include at least part of the application/device layer 210. The application services system 241 could be a middle tier of the interaction infrastructure 102 in some embodiments, with the data management system 266 corresponding to a back-end in some embodiments.

The application services system 241 and the data management system 266 each may be or include a server system 242 and a server system 267, respectively, that include one or more servers. In various embodiments, the server systems 242, 267 may include one or more computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, the server systems 242, 267 may be adapted to run one or more services, operations, processing, or software applications described herein. The server systems 242, 267 may run an operating system including any of those discussed above, as well as any commercially available server operating system. The server systems 242, 267 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Entity Machines), and the like.

In some embodiments, the server systems 242, 267 may include one or more applications to analyze and consolidate data feeds and/or event updates received from various data sources. As an example, data feeds and/or event updates may include, but are not limited to, application 206, 208 updates, Twitter® feeds, Facebook® updates, updates (real-time and/or otherwise) received from one or more third party information sources and/or continuous data streams, which may include real-time events related to sensor data applications, and/or the like. The server system 242 may also include one or more applications to display the data feeds and/or real-time events via the client devices 205, 207 and/or devices internal to the interaction infrastructure 102.

The application services system 241 and/or the data management system 266 may also include one or more data stores 268. The data stores 268 may retain any data suitable for embodiments of this disclosure. The data stores 268 may include database(s), database management system(s), server(s) to facilitate management/provision/transfer of data related to embodiments of this disclosure. In various embodiments, the data stores 268 may be implemented in various ways. For example, one or more relational or object-oriented databases, or flat files on one or more computers or networked storage devices, may store the information.

The data stores 268 may reside in a variety of locations, such as on a non-transitory storage medium local to (and/or resident in) the server systems 242, 267 and/or remote from the server systems 242, 267 and in communication with the server systems 242, 267 via a network-based or dedicated connection. In certain embodiments, the data stores 268 may reside in a storage-area network (SAN). Similarly, any necessary files for performing the functions attributed to the server systems 242, 267 may be stored locally on the server systems 242, 267 and/or remotely, as appropriate. In one set of embodiments, the data stores 268 may include relational databases that are adapted to store, update, and retrieve data in response to SQL-formatted commands. It should be appreciated that information corresponding to the repositories may be stored elsewhere and/or in other ways, or may not be stored, depending on the implementations chosen. Likewise, while various segregations of data corresponding to the repositories are provided herein, it should be appreciated that such examples are non-limiting, and some or all the data may be handled in any suitable manner.

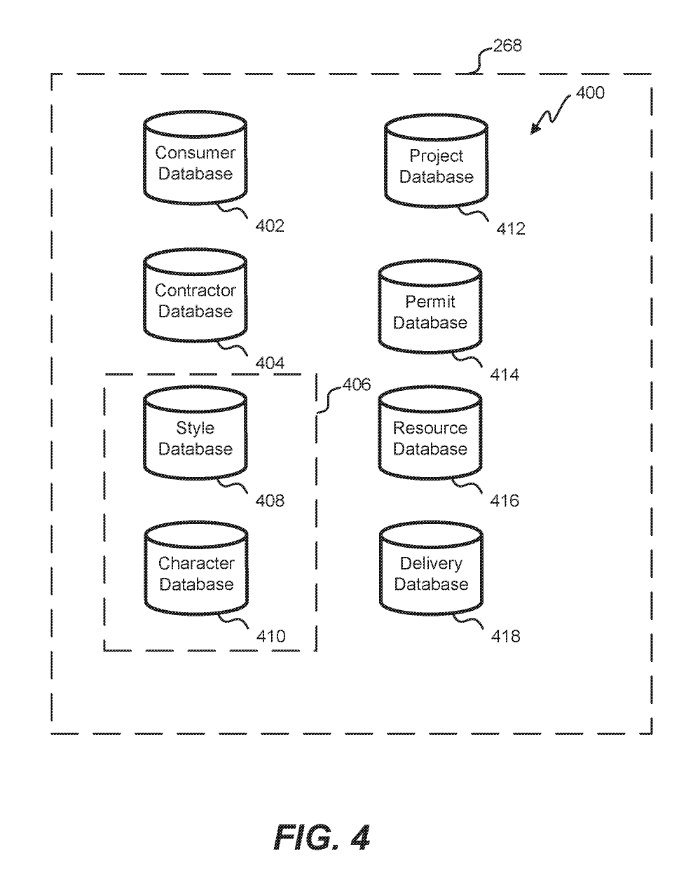

In some embodiments, the data stores 268 can comprise a plurality of databases, as is depicted in FIG. 4. FIG. 4 is a schematic depiction of one embodiment of databases 400. These databases 400 can include the client database 402 that can include one or several user accounts containing information relating to one or several clients. In some embodiments, the client accounts can include information such as, for example, information characterizing one or several aspects of the client's personality, working habits, design type, or the like. In some embodiments, the client account can further include information such as, for example, logon information including a username and a password.

These databases 400 can include a pro database 404, also referred to herein as the contractor database. The pro database 404 can include one or several pro accounts containing information relating to one or several pros. The pro accounts can include information such as, for example, information characterizing one or several aspects of the pro's personality, working traits, design type, credentials, reviews, or the like. In some embodiments, pro database 404 can include a portfolio containing pictures, descriptions, and/or other data relating to past projects performed and/or completed by the pro. In some embodiments, the pro account can further include information such as, for example, logon information including a username and password.

These databases 400 can include a prompt database 406, also referred to herein as a questions database, that can include one or several prompts or questions used in aggregating information to characterize one or several clients and/or the one or several pros. In some embodiments, questions database 406 can be divided into, and/or include a style database 408 and a character database 410. In some embodiments, the style database 408 can include information can be used to determine the style, such as a design type of one or both of the client and the pro. In some embodiments, this can include, for example, one or several pictures that capture one or several completed projects and/or aspects of one or several complete projects. In some embodiments, the style database 408 can further include questions relating to those one or several pictures that can be used, in connection with pictures, to determine the clients and/or pro preferences.

The character database 410 of the prompt database 416 can include one or several prompts that can be used to ascertain and/or determine the personality and/or character of the client and/or pro. In some embodiments, these prompts can be used to determine one or several personality traits of the client and/or pro, one or several working traits of the client and/or pro, or the like. Specifically, in some embodiments, a user can provide a response to one of the prompts, which response can be used as a feature in a predictive model to predict the one or several personality traits of the user and/or one or several working traits of the user.

The database server 104 can further include a project database 412. In some embodiments, the project database 412 can contain information relating to one or several projects provided by one or several clients. This information can include, for example, information defining the scope of the project, the desired start and/or finish of the project, charge for the project, one or several desired project outcomes, and/or the like. The information in the project database can be received from the client.

The database server 104 can include a permit database 414. The permit database can include information relating to one or several permits including, for example, building permits for one or several properties. In some embodiments, the database server 104 can include a resource database 416. The resource database can include information identifying one or several resources for use by the client. These resources can include, for example, one or several material suppliers, subcontractors, inspectors, lenders, sources for second opinions, or the like.

In some embodiments, the database server 104 can include a delivery database 418. The delivery database 418 can include content to assist the user in completion and/or management of the project. This content can include, for example, one or several learning modules identifying steps to the completion of the project and/or best practices for the completion the project.

In certain embodiments, the interaction infrastructure 102 may be implemented in or with a distributed computing and/or cloud computing environment with a plurality of servers and cloud-implemented processing, memory, and data resources. Thus, with accretion of service information, the system may allow for scaling out with additional processing resources, server resources, data storage resources, data management resources, and the like. Some embodiments may use different types of servers to service different types of client device 205, 207.

The interaction infrastructure 102 may offer services provided by one or more components of the interaction infrastructure 102, and, in some embodiments, one or more of the services may be offered as cloud services. A specific instantiation of a service 202 provided by the interaction infrastructure 102 may be referred to herein as a service instance 202. In some examples, a service 202 provided by the interaction infrastructure 102 may include provisioning of content objects, facilitating real-time communications, exposing features of a provider platform, exposing features of an orchestration platform, providing protected computer network access to data generated and/or transformed, and stored by the infrastructure system 102, for example, via a hosted database, a hosted web server, a hosted application server, a software application, and/or the like. In certain embodiments, the interaction infrastructure 102 may include a suite of applications, middleware, and database service offerings that are delivered to clients and/or providers.

In the illustrated embodiment, one or more client devices 205, 207 may be used by users to interact with the interaction infrastructure 102. Although only a limited number of the client devices 205, 207 is shown, any number of client devices 205, 207 may be supported. In various embodiments, the client devices 205 and/or 207 may correspond to devices supporting and/or accessing a client interface 105 and/or a service tool interface 107. In some embodiments, the client devices 205 and/or 207 may correspond to devices supporting and/or accessing a data acquisition interface 111 and/or a media channel interface 114.

In various embodiments, the client devices 205 and/or 207 may be configured to operate a client application such as a web browser, a proprietary client application, a web-based application, an entity portal, a mobile application, a widget, or some other application, which may be used by a user of the client device 205, 207 to interact with the interaction infrastructure 102 to use services provided by the interaction infrastructure 102. The client devices 205 and/or 207 may be portable handheld devices (e.g., an iPhone®, cellular telephone, an iPad®, computing tablet, a personal digital assistant (PDA)) or wearable devices (e.g., Google Glass® device), running software such as Microsoft Windows Mobile®, and/or a variety of mobile operating systems such as iOS, Windows Phone, Android, BlackBerry 10, Palm OS, and/or the like, and being Internet, e-mail, short message service (SMS), Blackberry®, and/or other communication protocol enabled. In some embodiments, one or more of the client devices 205 and/or 207 can be general purpose personal computers including, by way of example, personal computers and/or laptop computers running various versions of Microsoft Windows®, Apple Macintosh®, and/or Linux operating systems. In some embodiments, one or more of the client devices 205 and/or 207 can be workstation computers running any of a variety of commercially-available UNIX® or UNIX-like operating systems, including without limitation the variety of GNU/Linux operating systems, such as for example, Google Chrome OS. Alternatively, or in addition, one or more of the client devices 205 and/or 207 may be any other electronic device, such as a thin-client computer, an Internet-enabled gaming system (e.g., a Microsoft Xbox gaming console with or without a Kinect® gesture input device), and/or a personal messaging device, capable of communicating over network(s) 108.

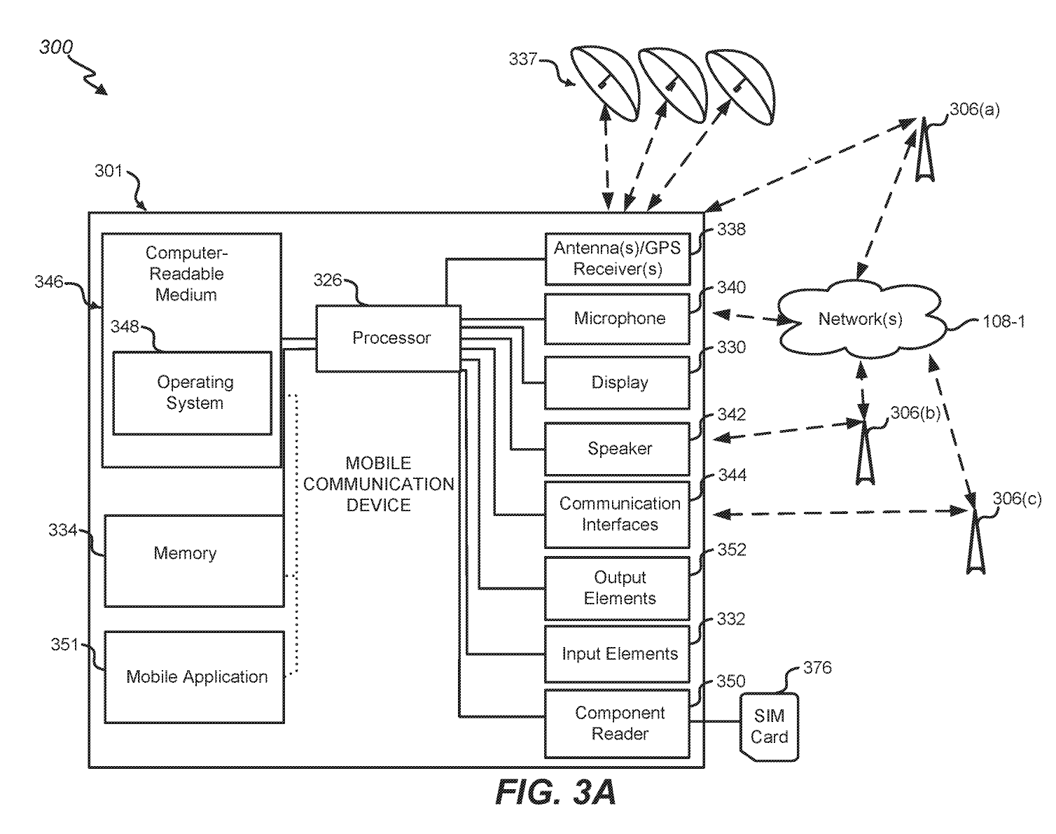

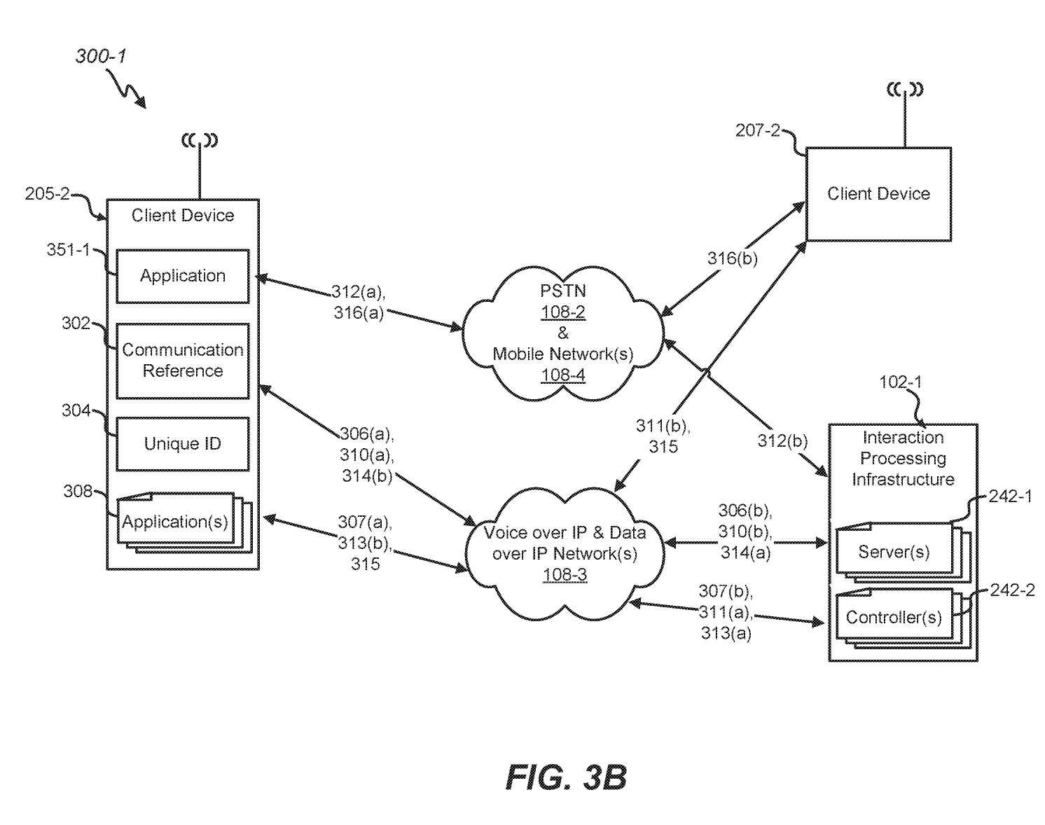

FIG. 3A is a block diagram of a system 300 including one non-limiting example of a client device 205 and/or 207 that corresponds to a computing device or a mobile communication device 301, in accordance with certain embodiments of the present disclosure. The mobile communication device 301 may be a portable device suitable for sending and receiving information over a network in accordance with embodiments described herein. For example without limitation, in various embodiments, the mobile communication device 301 may include one or more variously referenced as a personal computer, a mobile phone, a cellular telephone, a smartphone (for example without limitation, a smart phone such as: the iPhone® phone available from Apple Inc. of Cupertino, Calif.; Android™ operating system-based phones, available from as Google of Mountain View, Calif.; and/or the like), a handheld mobile device, a tablet computer, a web pad, a personal digital assistant (PDA), a notebook computer, a handheld computer, a laptop computer, a vehicle computer, and/or the like.

In some embodiments, the mobile communication device 301 may be provided with a mobile application 351, which may correspond to a client application configured to run on the mobile communication device 301 to facilitate various embodiments of this disclosure. In various embodiments, the mobile application 351 may correspond to application 206 and/or 208. For example without limitation, the mobile application 351 may transform the mobile communication device 301 into a communication tracking facilitator. The mobile application 351 and the mobile communication device 301 may cooperate with the interaction infrastructure 102 to facilitate tracking and/or handling of communications (e.g., calls, messages, chats, video conferencing, and/or the like) in response to content objects presented through the mobile communication device 301. The mobile application 351 can be a computer program that can be installed and run on the mobile communication device 301.

In various embodiments, mobile communication device 301 configured with the mobile application 351 may provide one or more display screens that may each include one or more user interface elements. A user interface may include any text, image, and/or device that can be displayed on a display screen for providing information to a user and/or for receiving user input. A user interface may include one or more widgets, text, text boxes, text fields, tables, grids, charts, hyperlinks, buttons, lists, combo boxes, checkboxes, radio buttons, and/or the like. As shown in FIG. 3, the mobile communication device 301 includes a display 320 and input elements 332 to allow a user to input information into the mobile communication device 301. By way of example without limitation, the input elements 332 may include one or more of a keypad, a trackball, a touchscreen, a touchpad, a pointing device, a microphone, a voice recognition device, or any other appropriate mechanism for the user to provide input. Further, the mobile communication device 301 the input elements 332 may include a communication component reader 350 for accepting a communication component such as a SIM card 376.

In some embodiments, the interaction infrastructure 102 may provide content objects of any suitable type to a user of the mobile communication device 301 through the mobile application 351. The mobile application 351 can include a utility that communicates with the interaction infrastructure 102 to control downloading, displaying, caching, and/or other operations concerning the handling of content objects. The mobile application 351 and the mobile communication device 301 may cooperate with the interaction infrastructure 102 to facilitate communication tracking in response to content objects displayed through the one or more additional applications.

In some embodiments, the client device 205 and/or 207 may include one or more additional applications, for example, that may be provided by one or more intermediaries and/or may provide functionality relating to one or more intermediaries. An intermediary may be any entity, including, for example, a news content provider, a social networking company, any entity, a gaming company, a music vendor, a multimedia content provider, and/or the like. Content objects (e.g., media objects, multimedia objects, electronic content objects, and/or the like) of any of various types may be displayed through the one or more additional applications. The mobile application 351 and the mobile communication device 301 may cooperate with the interaction infrastructure 102 to facilitate communication tracking in response to content objects displayed through the one or more additional applications. In some embodiments, the mobile application 351 could include a toolkit with client-side utility for interfacing with the one or more additional applications to facilitate tracking and/or call handling responsive to presented content. In some embodiments, the one or more additional applications could include the toolkit. In some embodiments, the mobile application 351 could be grafted into the one or more additional applications to provide tracking and/or communication handling functionalities. In some embodiments, the mobile application 351 could use a number of API translation data sets configured to allow interface with the one or more additional applications.

The user selection of a user-selectable option corresponding to a content object may involve any one or combination of various user inputs. The user selection may be in the form of a keyboard/keypad input, a touch pad input, a track ball input, a mouse input, a voice command, etc. For example, the content object may be selected by the user by pointing and clicking on the content object. As another example, the content object may be selected by an appropriate tap or movement applied to a touch screen or pad of the mobile communication device 301. The selection of a content object may initiate a voice call, video call, message, chat, and/or other communication. In some embodiments, a telephone number may be presented in content information in a format such that, when the user selects a communication reference, the client device (e.g., a cellular phone or a computer) dials a telephone number corresponding to the communication reference. For example, the call could have been initiated by end-user selecting a click-to-call option displayed via the user device. In some embodiments, user devices can automatically dial the telephone number. For example, a Dual Tone Multi-Frequency (DTMF) generator can dial a phone number. In some embodiments, the user device may initiate the phone call through a VoIP system.

In some embodiments, the mobile application 351 can run continuously (e.g., in the background) or at other times, such as when the mobile application 351 is launched by an end-user. In certain embodiments, the mobile application 351 can automatically run each time that a user accesses the one or more additional applications or selects a content object. The mobile application 351 may be provided in any suitable way. For non-limiting example, the mobile application 351 may be made available from the interaction infrastructure 102, a website, an application store, etc. for download to the mobile communication device 301; alternatively, it may be pre-installed on the mobile communication device 301. In some embodiments, the mobile application 351 can be pre-installed on the device platform by a mobile communication device manufacturer or carrier. In some embodiments, a mobile application 351 can be downloaded and installed by an end-user on their client device 205 and/or 207.

The mobile communication device 301 includes a memory 334 communicatively coupled to a processor 336 (e.g., a microprocessor) for processing the functions of the mobile communication device 301. The mobile communication device 301 may include at least one antenna 338 for wireless data transfer to communicate through a cellular network, a wireless provider network, and/or a mobile operator network, such as GSM, for example without limitation, to send and receive Short Message Service (SMS) messages or Unstructured Supplementary Service Data (USSD) messages. The mobile communication device 301 may also include a microphone 340 to allow a user to transmit voice communication through the mobile communication device 301, and a speaker 342 to allow the user to hear voice communication. The antenna 338 may include a cellular antenna (e.g., for sending and receiving cellular voice and data communication, such as through a network such as a 3G or 4G network). In addition, the mobile communication device 301 may include one or more interfaces in addition to the antenna 338, e.g., a wireless interface coupled to an antenna. The communications interfaces 344 can provide a near field communication interface (e.g., contactless interface, Bluetooth, optical interface, etc.) and/or wireless communications interfaces capable of communicating through a cellular network, such as GSM, or through Wi-Fi, such as with a wireless local area network (WLAN). Accordingly, the mobile communication device 301 may be capable of transmitting and receiving information wirelessly through both short range, radio frequency (RF) and cellular and Wi-Fi connections.

Additionally, the mobile communication device 301 can be capable of communicating with a Global Positioning System (GPS) 337 in order to determine to location of the mobile communication device 301. The antenna 338 may be a GPS receiver or otherwise include a GPS receiver. In various embodiments contemplated herein, communication with the mobile communication device 301 may be conducted with a single antenna configured for multiple purposes (e.g., cellular, GPS, etc.), or with further interfaces (e.g., three, four, or more separate interfaces).

The mobile communication device 301 can also include at least one computer-readable medium 346 coupled to the processor 336, which stores application programs and other computer code instructions for operating the device, such as an operating system (OS) 348. In some embodiments, the mobile application 351 may be stored in the memory 334 and/or computer-readable media 346. In some embodiments, the mobile application 351 may be stored on the SIM card 376. In some embodiments, mobile communication device 301 may have cryptographic capabilities to send encrypted communications and/or messages protected with message hash codes or authentication codes. Again, the example of mobile communication device 301 is non-limiting. Other devices, such as those addressed herein, may interact with the interaction infrastructure 102.

The mobile communication device 301 may access the network 108 through a wireless link to an access point. For example, a mobile communication device 301 may access the network 108 through one or more of access point 306(a), access point 306(b), access point 306(c), and/or any other suitable access point(s). The access points 306 may be of any suitable type or types. For example, an access point 306 may be a cellular base station, an access point for wireless local area network (e.g., a WiFi access point), an access point for wireless personal area network (e.g., a Bluetooth access point), etc. The access point 306 may connect the mobile communication device 301 to the network 108, which may include the Internet, an intranet, a local area network, a public switched telephone network (PSTN), private communication networks, etc. In some embodiments, access point(s) 306 may be used in obtaining location information for the mobile communication device 301, as described further herein.

FIG. 3B depicts a high-level block diagram of a system 300-1 for communication routing and tracking, in accordance with certain embodiments of the present disclosure.

The client device 205 configured with the application 351-1 may be configured to associate the application 351-1 with a communication reference 302 of the client device 205. In some embodiments, the communication reference 302 is a telephone number associated with the client device 205. In some embodiments, the application 351-1 may gather the telephone number from the device, a carrier associated with device subscriber, or via input of the end-user. In some embodiments, the application 351-1 may register unique identification information 304 associated with the client device 205. For example without limitation, the application 351-1 may gather the information 304 from the client device 205. In some embodiments, unique identification information 304 may be gathered from a SIM card 376 or another card of the client device 205. In some embodiments, unique identification information 304 may be gathered from other components of the client device 205.

The unique identification information 304 may be sent by the client device 205 to the infrastructure 102. The unique identification information 304 could include any suitable subscriber identity information. In some embodiments, the unique identifier may include an IMSI. In some embodiments, the unique identifier may be derived from the IMSI such that the actual IMSI is not sent. In some embodiments, a hash code based on the IMSI may be sent. The unique identifier may indicate associated network location information in some embodiments.

In some embodiments, to provision tracking service, the client device 205 configured with the application 351-1 may send provisioning information to the infrastructure 102. The provisioning information may indicate communication reference information 302. For example without limitation, as indicated by interactions 306(a) and 306(b), the client device 205 may send phone number information to the infrastructure 102. In some embodiments, the provisioning information could be sent to a MSC/HLR, which could then convey the information to the infrastructure 102. In some embodiments, the provisioning information could be sent via SMS messaging, as indicated by interactions 312(a) and 312(b). For example without limitation, SMS messaging may be sent to the infrastructure 102 via one or more of a home carrier MSC, a home carrier SMSC, an intercarrier SMS gateway, serving carrier SMSC, a mobile network 108-4, a serving carrier MSC/VLR, and/or the like.

Provisioning could be initiated with launching/installing the application 351-1. The provisioning information may be sent to the infrastructure 102 via an Internet Protocol (IP) message via one or more IP networks, such as network(s) 108-3. In some embodiments, the provisioning information may include the subscriber's Mobile Directory Number (MDN) for CDMA networks or Mobile Subscriber Integrated Services Digital Network Number (MSISDN) for GSM networks. In some embodiments, the client device 205 configured with the application 351-1 may also send provisioning information that includes the device's unique equipment identity 304. When necessary, the infrastructure 102 could request the subscriber's unique subscriber identity from the home location register associated with the MDN or MSISDN. The infrastructure 102 may store the provisioning information in one or more data repositories 140. In some embodiments, after the infrastructure 102 receives the provisioning information, it may send a confirmation message to the application 351-1, as indicated by interfaces 314(a) and 314(b).

As discussed herein, in some embodiments, the infrastructure 102 may provide particularized content objects through the application 351-1. In some embodiments, particularized content objects may be displayed through the one or more additional applications 308 of the client device 205, such as a browser, an SMS application, a push notification, an email application, a social media application, etc. In some embodiments, the application 351-1 could include a toolkit with client-side utility for interfacing with the one or more additional applications to facilitate tracking and/or call handling responsive to presented particularized content objects. Various embodiments may present particularized content objects in any one or combination of ways. In some embodiments, the one or more additional applications 308 could include a toolkit for interfacing with the application 351-1. In some embodiments, the application 351-1 could be grafted into the one or more additional applications to provide tracking and/or call handling functionalities. In some embodiments, the application 351-1 could use one or more API translation data sets configured to allow interface with the one or more additional applications 308.

The end-user may select a user-selectable call option presented with the client device 205 responsive to a particularized content object presented via the client device 205 either via the application 351-1 or via another application, in accordance with various embodiments. In some embodiments, the user-selectable call option and the particularized content object may be integrated, for example without limitation, with a particularized content object with a click-to-call option. In some embodiments, responsive to the user selection, a call may be placed to a provider communication device 207, as indicated by interactions 316(a) and 316(b).

Responsive to the user selection, the client device 205 configured with the application 351-1 may send one or more communications corresponding to the particularized content object, via a data network, to the infrastructure 102, as indicated by interactions 310(a) and 310(b). By way of example without limitation, the one or more communications may include one or more IP messages sent via one or more IP networks, such as network(s) 108-3. The one or more messages may convey tracking information. The tracking information could indicate call information. By way of example without limitation, the call information could correspond to the telephone number, the subscriber identity, the device identification, the IMSI, and/or any suitable information associated with the client device 205.

In some embodiments, particularized content objects are presented to a user via the application 351-1 such that the application 351-1 is configured to gather tracking information about those particularized content objects. In some embodiments, calls are placed or at least initiated via the application 351-1 such that the application 351-1 is configured to gather tracking information about those calls. In some embodiments, the application 351-1 receives, pulls, extracts, and/or listens to information from one or more applications 308 of the client device 205 to gather tracking information, where particularized content objects are presented via the one or more applications 308 and/or calls are placed or at least initiated via the one or more applications 308. In some embodiments, tracking information may include call information gathered from a phone application 308 of the client device 205.

FIG. 2B shows a diagram of a portion 200-2 of the architecture stack 200 of the interaction infrastructure 102, in accordance with certain embodiments of the present disclosure. The portion 200-2 at least partially includes the interface layer 215, the access management layer 220, and the application services management layer 240. In some embodiments, the application services system 241 may correspond at least partially to the interface layer 215, the access management layer 220, and the application services management layer 240. While engines, repositories, and other components are described separately in this disclosure, it should be appreciated that the components may be combined and/or implemented differently in any combination to provide certain features in various embodiments. In various embodiments, different processes running on one or more shared resources may implement some of the components.

The interaction processing infrastructure 102 may include one or more network interfaces 211 communicatively coupled to one or more servers, which may include communication servers, web servers, gateways, application servers, database servers, and/or one or more other types of servers. The network interface(s) 211 may include any suitable input/output module or other system/device operable to serve as an interface between one or more components of the interaction infrastructure 102 and the network 108. The interaction infrastructure 102 may use the network interfaces 211 to communicate over the network 108 using any suitable transmission protocol and/or standard.

The interface layer 215 may include one or more interface engines 212. The interface engine 212 may be configured to generate one or more interfaces 105, 107, 111, 114 (e.g., web interfaces 213, mobile app interfaces 214, graphical user interfaces 216, enterprise application interfaces 217, programmatic interfaces 218, and/or the like) to enable data to flow to client devices 205, 207 via respective applications 206, 208. In various embodiments, the interfaces of interface engine 212 may be embodied in hardware and/or software. The interface engine 212 may include logic to send, present, and receive information, with one or more of the interfaces to/from one or more end users, service providers, and/or data sources. The interface engine 212 may utilize one or more network interfaces to transceive information through the network 108. The interaction infrastructure 102 may pull and/or push information from those entities.

Generally, interfaces may be configured to receive user input, present dynamic presentations that depend on user input, and otherwise respond to user input. In some examples, such input may be provided via one or more input devices (e.g., a keyboard, touchscreen, joystick, mouse, microphone, devices capable of capturing inputs, and the like) operated by one or more users of user devices. Output may be provided via one or more output devices 352 (e.g., a display or speaker). The web interfaces 213 and mobile interfaces 214 may include any suitable web interface and mobile interface configured to interact with elements of the interaction infrastructure 102. The graphical user interfaces 216 may include any suitable graphical user interface configured to interact with elements of the interaction infrastructure 102. The enterprise interface 217 may include internal interfaces for accessing element of the interaction infrastructure 102 via an internal network of an enterprise. The programmatic interfaces 218 may include one or a combination of an API, a programmatic user interface, and/or other similar interfaces for defining core functions for accessing elements of the interaction infrastructure 102. A programmatic interface 218, for example, may specify software components in terms of associated operations.

Elements of the interface layer 215, for example, the interface engine 212, may communicate with calls and inputs directed to and/or received from the access management layer 220. In some embodiments, the access management layer 220 may include one or more identity management engines 219. Generally, the identity management engine 219 can be configured to provide identity services, such as access management and authorization services for end users and/or providers serviced by the interaction infrastructure 102. In some embodiments, the identity management engine 219 may control information about end users and providers that utilize the services provided by the interaction infrastructure 102. The control information may include information that authenticates the identities of end users and/or providers and that specifies authorized actions with respect to various system resources and services.

In some embodiments, the identity management engine 219 may include logic for implementing account features in various embodiments. By way of example without limitation, the identity management engine 219 may include logic one or more aspects of: handling user registration; managing account creation, updates, authentication, handling; and/or the like. The identity management engine 219 may be configured for acquiring, processing, formatting, and/or storing authentication information in the one or more authentication information repositories 257.

In some embodiments, the identity management engine 219 may include a plurality of engines configured to manage different aspects of interacting with elements of the interaction infrastructure 102, such as user interactions with applications serviced by the interaction infrastructure 102. The engines may include, for example, an authentication access engine 221, a login engine 222, and a billing engine 223. The different engines of the identity management engine 219 can define routines, protocols, standards, and/or the like for interacting with elements of the interaction infrastructure 102. The authentication access engine 221 may evaluate rules and conditions under which users may access elements of the interaction infrastructure 102. These rules and conditions may be user-defined (e.g., by an administrator or reviewer), learned over time, and/or may be dynamically updated and/or evaluated based on characteristics of the user or the user's device attempting to access the interaction infrastructure 102. The login engine 222 may evaluate the rules and conditions under which users are able to log in to the interaction system or access applications associated with the interaction system. Thus, while authentication access engine 221 may evaluate the rules to determine which users may access the interaction infrastructure 102, the login engine 222 may evaluate the particular credentials, data sets, etc. associated with each authenticated user.

The application services management layer 240 may include one or more service management engines 224. The service management engines 224 may include one or more service orchestration engines 226, one or more service provisioning engines 227, and/or one or more service monitoring engines 228. By way of example without limitation, in some embodiments, a client device 205 or 207 running an application 206 or 208 may interact with the interaction infrastructure 102 by transmitting a service request 201 to the interaction infrastructure 102 for one or more services provided by the interaction infrastructure 102. In some embodiments, the service request 201 may be received via an interface facilitated by the interface engine 212. The service request 201 may be processed by the service management engine 224 and, consequent to the processing, information identifying one or more services and, in some embodiments, information uniquely identifying a user. The service orchestration engine 226 may utilize the information to orchestrate the provisioning of services and resources responsive to the service request 201. In some embodiments, the service orchestration engine 226 may orchestrate the provisioning of services and resources using the service provisioning engine 227. In certain embodiments, the service orchestration engine 226 may enable the management of processes associated with each service request 201 and may apply entity logic to determine whether and how a service 202 should be provisioned. The service orchestration engine 226 may send a request to the service provisioning engine 227 to prompt the service provisioning engine 227 to allocate resources and configure those resources needed for the service 202. The service 202 may be tracked by the service monitoring engine 228. In some instances, the service monitoring engine 228 may be configured to collect usage statistics for the services 202.

FIG. 2C shows a diagram of another portion 200-3 of the architecture stack 200 of the interaction infrastructure 102, in accordance with certain embodiments of the present disclosure. In particular, the portion 200-3 at least in partially includes the data acquisition layer 225, the aggregation and transformation layer 260, and the transformed data layer 275. The data acquisition layer 225 may receive data from components 229. In various embodiments, the components 229 may correspond to any one or combination of data sources disclosed herein and/or the like, with aggregation being facilitated in some embodiments with any one or combination of interfaces 105, 107, 111, 114 and/or client devices 205, 207. In some embodiments, the components 229 may include complimentary layers to facilitate data transmission, such as a transmission layer, generation layer, and/or a receiving layer to communicate and/or receive data via the data acquisition layer 225. In various embodiments, the input from the components 229 may correspond to any one or combination of raw data, unstructured data, structured data, information, and/or content which may include media content, text, documents, files, instructions, code, executable files, images, video, audio, and/or any other suitable content suitable for embodiments of the present disclosure. For example, data from 20, 200, or any number of different sources may be merged together with data generated internally, data previously received, data from third parties, etc. The data could relate to end users, providers, entities, geographic locations, demographic information, and/or the like. For example, the aggregation and transformation layer 260 may identify which data and records are about the same entity and may merge attributes from different sources into one composite object that can be used by the application services as a basis for services provided.

The aggregation and transformation layer 260 may provide a pipeline that processes data input from the components 229, applies rules, transforms the data, and feeds the transformed data to the transformed data layer 275 and/or the application services management layer 240. The aggregation and transformation layer 260 may include one or more aggregation and/or transformation engines 231. In various embodiments, the aggregation and/or transformation engine 231 may correspond to an integral engine or separate engines working in conjunction. The aggregation/transformation engine 231 may transform, translate, or otherwise adjust data collected. In some embodiments, two or more of the components 229 may generate data according to different formats. The data can then be transformed, translated, or otherwise adjusted by the engine 231. For example, acquired data may be converted from a first format to a second format using one or more conversion rules, which may be user-defined, heuristic, and/or machine-learned. In some embodiments, the transformation engine 231 may perform similar operations with respect to other data generated by elements of the interaction infrastructure 102.

In some embodiments, the aggregation and/or transformation engines 231 may include one or more transformational adaptors 232. In some embodiments, one or more transformational adaptors 232 may be associated with the components 229 to effect the transformations. The transformational adaptors 232 may be implemented, in various embodiments, in hardware and/or software. In some embodiments, a transformational adaptor 232 may include a hardware device and/or software component that transforms, translates, converts, or otherwise adjusts the acquired data. In various embodiments, the adjustment operations may be executed within the data acquisition layer 225 and/or the transformation layer 260.

A consolidation engine 233 may process manifold data sets that may, for instance, come from different sources or the same source, for example, by way of one or more updates to data previously provided by a particular source, and the consolidation engine 233 may consolidate the data sets to form a composite data set. The consolidation may include organizing, categorizing, qualifying, and/or comparing the sets of information; detecting, identifying, and/or handling errors/discrepancies; and/or otherwise processing the data sets. In some embodiments, the consolidation engine 233 may identify subset of entities that are more important than the rest, may process data to identify relations to at least one entity of the subset of entities, and may process data having such relation first. In some embodiments, the consolidation engine 233 may only consolidate the data having such relation and may disregard and/or dispose of data that does not possess such relation.

With certain embodiments, a data integrity engine 234 with one or more processors may check data sets to ensure quality of the data. The data integrity engine 234 may assess each piece of information relating to an aspect (e.g., data relating to a listing of information for an entity, such name, location, reviews, ratings, etc.) and may assign a weight to the information according to a score. Any suitable scoring system may be used. Missing information, for example, could have a lower score than non-missing information; and the missing information could be scored even lower, the more important the information is to the aspect. Information may be weighted according to the source. For example, in some instances, information relating to a company that is gathered from the company's website may be weighted higher or lower relative to information gathered from a third party's website; tracking data gathered from an end-user device, for example, may be considered more reliable than corresponding/conflicting information from a third party directory service. Scoring data sets (e.g., compiled for end users, providers, entities, etc.) based the information based upon the underlying reliability of information may avoid provisioning of misdirected, redundant, unwanted, and/or unnecessary services.

In certain embodiments, the data integrity engine 234 may examine items of information and assign scores according to how important such information is to services, generally. The data integrity engine 234 may take into account service categories. Data pertinent to service categories may be prepared as a basis for provisioning services corresponding to particular categories. In certain embodiments, the data integrity engine 234 may adjust scoring of information in view of a specific services and/or specific categories of services. In certain embodiments, the data integrity engine 234 may examine items of information in view of a specific services and/or specific categories of services upfront, thereby rendering subsequent readjustment unnecessary. Based on the scoring, certain data may be discarded or flagged for possible follow-up and/or prompting for further information and/or clarifying information may be identified, generated, and/or provided. Accordingly, composite content can be made more reliably with possible follow-up and/or prompting for a data source to link to for more missing information.

In various embodiments, a rules engine 237 may be configured to create and manage entity rules, condition-response rules, alert/reports rules, data-formatting rules, data-sharing rules, transmission rules, aggregation rules, user authorization rules, and other similar rules. Such rules may be user-defined, fixed, heuristics, learned by elements of the interaction infrastructure 102, and any combination of the foregoing. In some embodiments, the rules engine 237 may be included in the consolidation engine 233. In some embodiments, the rules engine 237 may be separate from the consolidation engine 233.

A build engine 236 may assess quality of the data and/or the data sources. The build engine 236 may build one best data set that relates to a particular entity. In some embodiments, the build engine 236 may build multiple high-quality data sets that relate to a particular entity, but are tailored for different purposes (e.g., different locations, publisher channels, medial channels, and/or the like).

A feed engine 239 may be configured to process received input 238 from the aggregation/transformation engine 231. In some embodiments, the feed engine 239 may be integral with the aggregation/transformation engine 231. The feed engine 239 may generate one or more feeds 241 transferred to the transformed data layer 275 (e.g., for storage) and/or the application services management layer 240 (e.g., for more immediate use, by the publication management layer 255 or another application service). In some embodiments, the feed engine 239 may generate a single feeder 241—a universal feed object—to feed the transformed data layer 275 and/or the application services management layer 240. The feed engine 239 may feed transformed data (which may include transformed information and/or transformed content in some embodiments).

In some embodiments, the feed engine 239 may implement a feeding process that feeds transformed data (which may include information and/or content in some embodiments) based on a last finishing point of a previous feeding process. The feed engine 239, in some embodiments, may push the transformed data/content/information into one or more temporary indexes. In some embodiments, the feed engine 239 may further transform the transformed data/content/information into a feed object with a data-interchange format that facilitates parsing. The feed engine 239 and/or the aggregation/transformation engine 231 may translate the data into understandable data, information, and/or content. The transformed data, information, and/or content may be directed to certain tables and/or data stores 268 based on the type of and/or an entity category to which the data, information, and/or content relates. For example, in some embodiments, the master data management system 265 may manages provider content and feeds into search indexes and the publishing system.

The feeding process may include multiple processes, in some embodiments. For example, the feed engine 239 may spin out two processes: one process for communicating with a search server system 267(a); and one process for communicating with a document server system 267(b). The search server system 267(a) and/or the document server system 267(b) may process the temporary index and determine which data is absent from the data stores 268. Consequent to determining which data is needed, the data may be fed to the data stores 268.

In some embodiments, the data may be feed to the search server system 267(a) and/or the document server system 267(b) on a periodic basis. The search server system 267(a), in some embodiments, may only retain in its search indexes information needed for retrieving content objects (e.g., documents) and ranking the content objects. Thus, with such embodiments, other information not necessary for retrieval and ranking (e.g., images corresponding to an entity). The document server system 267(b) may have every entity attribute indexed for information retrieval. This bifurcation may allow for the interaction infrastructure 102 to perform super-fast retrieval. The search server system 267(a), in some embodiments, may perform matching, sorting, and/or the like, and hence may be CPU heavy. The document server system 267(b), in some embodiments, may be a disk I/O intense system and can handle those kinds of loads.

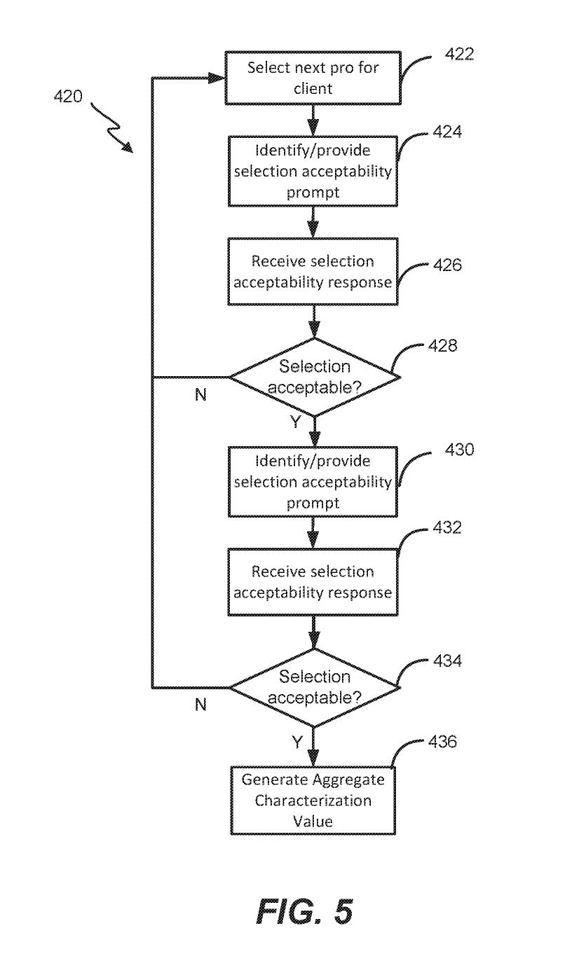

With reference now to FIG. 5, a flowchart illustrating one embodiment of a process 420 for generating and sending a selection alert is shown. In some embodiments, the process 420 can be performed by, for example, one of the servers of the server systems 242, 267. In some embodiments, the process 420 is performed in response to a request or prompt or indication from a client user, who is looking for pros to function to complete one or more projects for which information has been entered and is accessible to the server systems 242, 267. In some embodiments, the generating and sending of the selection alert can be based on the generation of a pairing value which can be determined based on one or several attributes of the clients and the pros using the system.

The process 420 begins at block 422 wherein the server performing the process 420 selects a pro or a next pro for a client. The selection, for example, may be made by the server by selecting a next pro from a ranked list of pros from a pro database, such as those discussed elsewhere herein. The ranks of the pros of the ranked list are determined or calculated by the server based on characteristic information of the pros in the pro database and characteristic information of the client in a client database, such as those discussed elsewhere herein. The rank for each particular pro may, for example, represent a relative appropriateness or fit of the particular pro for the client relative to the other pros. Nonlimiting examples of the selection process are described in further detail below.

After the process 420 has selected a next pro for the client, the process proceeds to block 424 wherein the server performing the process 420 identifies and/or provides one or several first selection acceptability prompts to the user via, for example one of the user devices 205, 207. In some embodiments, a first selection acceptability prompt can comprise one or several questions directed at the user regarding the users willingness to accept the selection made at block 422.

The first selection acceptability prompt may be provided to either the client or the pro selected at block 422. For example, the first selection acceptability prompt may include a description of various attributes of the client, for example, stored in project database 402, and of the project, for example, stored in project database 412. In such embodiments, the first selection acceptability prompt may be provided to the pro selected at block 422. Alternatively, the first selection acceptability prompt may include a description of various attributes of the pro, for example, stored in pro database 404. In such embodiments, the first selection acceptability prompt may be provided to the client.

After the first selection acceptability prompt is identified and/or provided, the process 420 proceeds to block 426 wherein a response to the provided first selection acceptability prompt is received. In some embodiments, and in response to the receipt of the first selection acceptability prompt, the user can provide a response to the first selection acceptability prompt in the form of inputs to the user device 205, 207. These inputs and/or the data from those inputs can be provided from the user device 205, 207 to one of the servers of the server systems 242, 267.

After the response to the first selection acceptability prompt has been received, the process 420 proceeds to block 428 wherein the server performing process 420 determines whether the selection made at block 422 is acceptable to the user having received the first selection acceptability prompt. For example, the server performing process 420 may determine that the selection made at block 422 is acceptable to the user having received the first selection acceptability prompt if the response to the first selection acceptability prompt indicates acceptability. Likewise, the server performing process 422 may determine that the selection made at block 422 is not acceptable to the user having received the first selection acceptability prompt if the response to the first selection acceptability prompt does not indicate acceptability.

If the server determines that the selection made at block 422 is not acceptable, the process 420 returns to block 422 wherein a next pro is selected.

If the server determines that the selection made at block 422 is acceptable, the process 420 proceeds to block 430 wherein the server performing the process 420 identifies and/or provides one or several second selection acceptability prompts to the user via, for example one of the user devices 205, 207. In some embodiments, a second selection acceptability prompt can comprise one or several questions directed at the user regarding the users willingness to accept the selection made at block 422.

The second selection acceptability prompt may be provided to either the client or the pro selected at block 422. For example, the second selection acceptability prompt may include a description of various attributes of the client, for example, stored in project database 402, and of the project, for example, stored in project database 412. In such embodiments, the second selection acceptability prompt may be provided to the pro selected at block 422. Alternatively, the second selection acceptability prompt may include a description of various attributes of the pro, for example, stored in pro database 404. In such embodiments, the second selection acceptability prompt may be provided to the client.

If the first selection acceptability prompt is provided to the pro, the second selection acceptability prompt is provided to the client. Likewise, if the first selection acceptability prompt is provided to the client, the second selection acceptability prompt is provided to the pro.

After the second selection acceptability prompt is identified and/or provided, the process 420 proceeds to block 432 wherein a response to the provided second selection acceptability prompt is received. In some embodiments, and in response to the receipt of the second selection acceptability prompt, the user can provide a response to the second selection acceptability prompt in the form of inputs to the user device 205, 207. These inputs and/or the data from those inputs can be provided from the user device 205, 207 to one of the servers of the server systems 242, 267.

After the response to the second selection acceptability prompt has been received, the process 420 proceeds to block 434 wherein the server performing process 420 determines whether the selection made at block 422 is acceptable to the user having received the second selection acceptability prompt. For example, the server performing process 420 may determine that the selection made at block 422 is acceptable to the user having received the second selection acceptability prompt if the response to the second selection acceptability prompt indicates acceptability. Likewise, the server performing process 422 may determine that the selection made at block 422 is not acceptable to the user having received the second selection acceptability prompt if the response to the second selection acceptability prompt does not indicate acceptability.

If the server determines that the selection made at block 422 is not acceptable, the process 420 returns to block 422 wherein a next pro is selected.

If the server determines that the selection made at block 422 is acceptable, the process 420 proceeds to block 436 wherein the server performing the process 420 generates a selection alert. In some embodiments, the selection alert can comprise data identifying the selection of pro made at block 422 for the client and computer code configured to activate the user device 205, 207 when the selection alert is received. In some embodiments, the selection alert can be further configured to direct and/or cause the user device 205, 207 to provide and/or display the selection to the user.

In some embodiments, the selection alert is sent to the pro selected at block 422. In some embodiments, the selection alert is sent to the client. In some embodiments, the selection alert is sent to both the pro selected at block 422 and to the client.

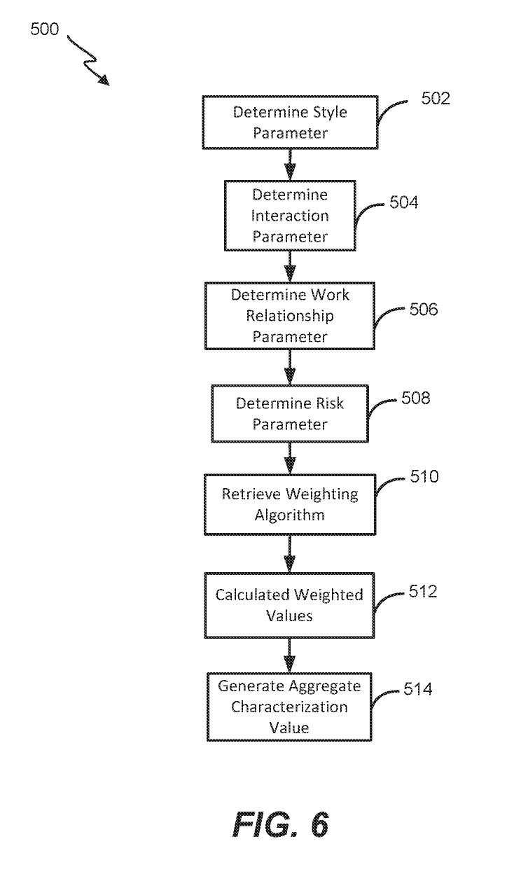

With reference now to FIG. 6, a flowchart illustrating one embodiment of a process 450 updating or entering information in a database, such as the pro database or the client database discussed above with reference to FIG. 5 or any one or more of the databases 400 of the database server 104 is shown. The process 450 is also used for generating and sending a characterization alert. In some embodiments, the process 450 can be performed by, for example, one of the servers of the server systems 242, 267. In some embodiments, the characterization alert can be generated and/or sent as part of the intake of a user.

In some embodiments, the updating or entering information in the database and generating and sending of a characterization alert can be based on the generation of a characterization value which can identify one or several attributes of the user. In some embodiments, the process 450 can be used for intaking a client, and in some embodiments, the process 450 can be used for intaking the pro.

The process 450 begins at block 452 wherein user (e.g. pro or client) identification information is received. In some embodiments, this information can include, for example, a username and a password, or the like.

In some embodiments, this information can identify a new user that does not currently have a user data set such as, for example, a client data set or a pro data set. If the user identification information identifies a new user, then a new user account is created in the database and the process 450 proceeds to block 454 wherein question data is retrieved. In some embodiments, the question data can be retrieved from one of the databases 400 of the database server 104 such as, for example, the question database 406.

After the question data has been retrieved, the process 450 proceeds to block 456 wherein one or several attribute prompts are identified and/or provided to the user via, for example one of the user devices 205, 207. In some embodiments, an attribute prompt can comprise one or several questions directed at the user and/or past user performance. In some embodiments, the one or several attribute prompts can be used to generate data to identify one or several personality related attributes of the user such as, for example, a personality type, a preferred working traits, preferred interaction type, or the like. In some embodiments, one or several attribute questions can be retrieved from, for example, the character database 410 or any one or more of the databases 400 of the database server 104.

Additionally, in some embodiments, one or several attribute questions can relate to one or several preferences of the user. These can include, for example, questions relating to preferred schemes, questions relating to liked and/or disliked architectural or interior design types, the like. In some such embodiments, the one or several attribute questions can be retrieved from any one or more of the databases 400 of the database server 104.

After the attribute prompts are identified, the process 450 proceeds to block 458 wherein attribute prompt responses are received. In some embodiments, and in response to the receipt of the attribute prompts, the user can provide one or several responses to the one or several attribute prompts in the form of inputs to the user device 205, 207. These inputs and/or the data from those inputs can be provided from the user device 205, 207 to one of the servers of the server systems 242, 267.

After the attribute prompt responses have been received, the process 450 proceeds to block 460 wherein one or several project prompts are identified and/or provided. In some embodiments, these one or several project prompts can be identified in and retrieved from the databases 400, and specifically, for example, from the project database 412. In some embodiments, the project prompts can be provided to the user via the user device 205, 207. In some embodiments, the project prompts can relate to attributes of the desired project such as, for example, the size of project, the charges for the project, desired start and/or completion for the project, the desired duration of the project, location of the desired project, or the like.

After the project prompts have been identified and provided, the process 450 proceeds to block 462 wherein the project prompt responses are received. In some embodiments, and in response to the receipt of the project prompts, the user can provide one or several responses to the one or several project prompts in the form of inputs to the user device 205, 207. These inputs and/or the data from those inputs can be provided from the user device 205, 207 to one of the servers of the server systems 242, 267.

After the project prompt responses have been received, the process 450 proceeds to block 464 wherein a characterization value is generated. In some embodiments, the characterization value can be generated based on answers received in response to one or several of the attribute questions and/or one or several of the project questions. Thus, in some embodiments, the characterization value can comprise a first component relating to one or several client attributes and a second component relating to one or several project attributes. In some embodiments, a weighting and/or scoring algorithm can be applied to these answers and can be used to determine the characterization value. In some embodiments, generation of the characterization value can include selecting and retrieving a prompt response; identifying a weighting value applicable to the selected prompt response; and applying the weighting value to the prompt response to generate a weighted prompt response value. In some embodiments, the generation of the characterization value can further include determining if a desired some, or all of the prompt response have been selected; and generating a characterization value from the weighted prompt response values if the desired some, or all of the prompt responses have been selected, or repeating the above identified steps until all of the prompt responses have been selected. In some embodiments, one of the servers of the server systems 242, 267 can generate the characterization value.

After the characterization value has been generated, the process 450 proceeds to block 466 wherein the characterization value is applied to or stored in any one or more of the databases 400 of the database server 104 in the user data set. In some embodiments, this can include updating one or more of the databases 400, and specifically can include updating one or more of the client database 402 and the pro database 404.

After the characterization value has been applied to or stored in the user data set, the process 450 proceeds to block 468 wherein the characterization associated with the characterization value is identified. In some embodiments, for example, this can include comparing the calculated characterization value to one or several values from, for example, a lookup table. In such an embodiment, a characterization can be identified as the characterization having an associated value closest to the calculated characterization value.

After the characterization has been identified, the process 450 proceeds to block 470 wherein a characterization alert is generated and sent. In some embodiments, the characterization alert can comprise data identifying the characterization of the user and/or the characterization value and computer code configured to activate the user device 205, 207 when the alert is received. In some embodiments, the characterization alert can be further configured to direct and/or cause the user device 205, 207 to provide and/or display the characterization and/or characterization value to the user.

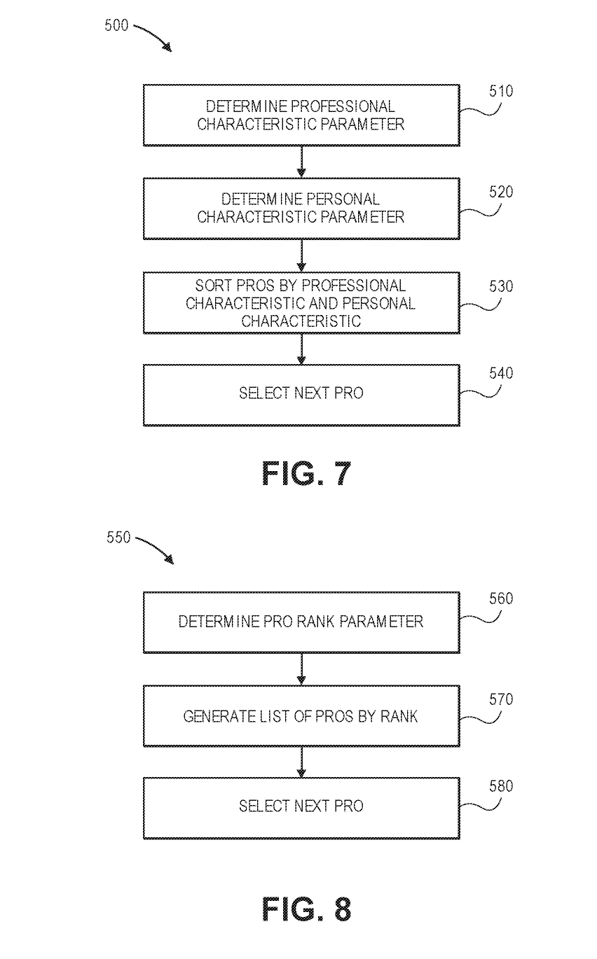

With reference now to FIG. 7, a flowchart illustrating one embodiment of a process 500 which is a more detailed embodiment of block 422 of process 420 illustrated in FIG. 5 wherein the server performing the process 420 selects a pro or a next pro from a set of candidate pros for a client or for a project for a client. In some embodiments, the process 500 can be performed by, for example, one of the servers of the server systems 242, 267.

The process 500 begins at block 510 wherein a professional characteristic parameter is determined. The professional characteristic parameter for each particular candidate pro may, for example, be determined based on certain characteristics of the particular candidate pro, for example, stored in any one or more of the databases 400 of the database server 104. The professional characteristic parameter may be calculated based on the characteristics of the particular candidate pro as compared or related to client or project desires or requirements corresponding with the characteristics.

Certain examples of calculating the professional characteristic parameter based on characteristics of particular candidate pros and client or project desires or requirements are discussed below in more detail.

Characteristics of each particular candidate pro used for determining the professional characteristic parameter may, for example, include capabilities of the particular candidate pro, charge of the particular candidate pro, and an expected of completion of the project for the particular candidate pro. Other characteristics may additionally or alternatively be used. Desires or requirements of the client or project corresponding with the characteristics of the candidate pros may, for example, respectively include particular capabilities required for the project, charges, and project completion. Other desires or requirements of the client or project corresponding with the characteristics of the candidate pros may additionally or alternatively be used.

Additionally or alternatively, characteristics of each particular candidate pro used for determining the professional characteristic parameter may, for example, include areas of specialty or expertise of the particular candidate pro. Other characteristics may additionally or alternatively be used. Desires or requirements of the client or project corresponding with the characteristics of the candidate pros may, for example, additionally or alternatively include areas of specialty or expertise desired or required for the project. Other desires or requirements of the client or project corresponding with the characteristics of the candidate pros may additionally or alternatively be used.

Additionally or alternatively, characteristics of each particular candidate pro used for determining the professional characteristic parameter may, for example, include location or distance information. For example, the location of an area the particular candidate pro is customarily in or a distance from the location of the project to the area may be included. Other location or distance characteristics may additionally or alternatively be used.

For each desire or requirement of the client or project, a corresponding characteristic of the candidate pro is determined, and a mathematical professional characteristic parameter value corresponding with a fit or appropriateness for pairing the candidate pro and the client/project is calculated. For example, if the client is interested in saving money by sacrificing detailed craftsmanship or another quality related parameter, candidate pros having lower quality and lower price characteristics will receive more favorable professional characteristic parameter values. Similarly, if the client is interested in a quick completion of the project, candidate pros having fast completion characteristics will receive more favorable professional characteristic parameter values.

In some embodiments, location or distance information associated with each particular pro is used to determine which of the pros may be considered as a candidate pro. For example, if the distance information indicates that a particular pro is too far from the project, the particular pro may be excluded from the list of candidate pros.

As an example, in some embodiments, the professional characteristic parameter is a weighted sum of a professional characteristic parameter project type parameter and a specialty parameter. In some embodiments, the weighting of the summed project type and specialty parameters is equal. In alternative embodiments, the weighting of the summed project and specialty parameters is not equal.

In some embodiments, the project type parameter for a particular pro is calculated based on capabilities of the particular candidate pro, fees of the particular candidate pro, an expected of completion of the project for the particular candidate pro, and a prioritized ranking from the client regarding quality of the project, completion of the project, and fees for the project.

For example, a client may be interested in completing a home improvement project. Based on the details of the project, the various types of pros are categorized as one of 3 levels of necessity: 1) must have, 2) good to have, and 3) optional.

The project type parameter for each particular pro may be calculated based on the level of necessity of the type of each particular pro and on the prioritized ranking from the client. For example, the table below an embodiment of a point allocation scheme based on these factors.

| Pro type necessity | Client first priority | Points |
|---|---|---|
| 1 | Any or none | 1000 |
| 2 | Quality | 400 |
| 2 | Completion | 300 |
| 2 | Charge | 200 |
| 2 | None | 100 |
| 3 | Quality | 40 |
| 3 | Completion | 30 |
| 3 | Charge | 20 |
| 3 | None | 10 |

Accordingly, pros which are necessary for a project may have a 1 necessity level, and therefore receive 1000 points. In addition, pros which have a 2 necessity level and will receive 100, 200, 300, or 400 points based on the prioritized ranking from the client.

Other point allocation schemes may be used to calculate the project type parameter for each particular pro.

In some embodiments, the specialty parameter for a particular pro is calculated based on any specialties of the particular candidate pro. Based on the details of the project, the various specialties of pros are categorized as one of 3 levels of necessity: 1) must have, 2) good to have, and 3) optional.

The specialty parameter for each particular pro may be calculated based on the level of necessity of a specialty of each particular pro. For example, the table below an embodiment of a point allocation scheme based on these factors.

| Pro specialty necessity | Points |
|---|---|
| 1 | 1000 |
| 2 | 100 |
| 3 | 10 |

Accordingly, pros having a specialty of 1 necessity level receive 1000 points. In addition, a pro with a specialty with a 2 necessity level receive 100 points.

Other point allocation schemes may be used to calculate the specialty parameter for each particular pro.

As discussed above, the professional characteristic parameter may be a weighted sum of the project type parameter and the specialty parameter. Other methods may be used to calculate the professional characteristic parameter.

Once the professional characteristic parameter for a particular candidate pro or a group of candidate pros is determined, the process proceeds to block 520 wherein a personal characteristic parameter is determined. The personal characteristic parameter for each particular candidate pro may, for example, be determined based on certain characteristics of the particular candidate pro, for example, stored in any one or more of the databases 400 of the database server 104. The personal characteristic parameter may be calculated based on the characteristics of the particular candidate pro as compared or related to client or project desires or requirements corresponding with the characteristics.

Certain examples of calculating the personal characteristic parameter based on characteristics of particular candidate pros and client or project desires or requirements are discussed below in more detail.

Additionally or alternatively, characteristics of the particular candidate pro related to personal interactions with clients. For example, work habits, such as noise, language, cleanliness, communication with client as reported by the particular candidate pro and/or reports from other clients of the particular candidate pro may be used to determine the personal characteristic parameter for each particular candidate pro. Other characteristics of the candidate pros related to personal interaction with clients may additionally or alternatively be used.

For example, in some embodiments, the personal characteristic parameter is a weighted sum of a Personality parameter and an Objective parameter. In some embodiments, the weighting of the summed Personality and Objective parameters is equal. In alternative embodiments, the weighting of the summed Personality and Objective parameters is not equal.

In some embodiments, the Personality parameter for a particular pro is calculated based on a personality test.

The characteristics of each particular candidate pro used for determining the Personality parameter may, for example, include a score or a value or a characterization as determined by a personality test for the particular candidate pro. For example, a personality test based on Jung and/or Briggs Meyers theories on personality or an OCEAN Big 5 personality test may be used to determine a personality score or value or characterization of each particular candidate pro. Other personality tests may alternatively be used to determine a personality score or value or characterization of each particular candidate pro.

The characteristics of each particular candidate pro used for determining the Personality parameter may, for example, include a score or a value or a characterization as determined by a personality test for the client. For example, the personality test based on Jung and/or Briggs Meyers theories on personality, OCEAN Big 5 personality test, or other test may be used to determine a personality score or value or characterization of the client.

In addition to determining a personality score or value or characterization, the personality test also provides an assessment of the fit of one personality type with the other personality types of the personality test. The Personality parameter for each particular candidate pro is determined by the fit assessment based on the results of the personality test for the particular pro and the results of the personality test for the client. For example, if the personality type of a particular pro is very compatible with the personality type of the client, the Personality parameter of the particular pro may be allotted a high number of points, such as 12 points. In contrast, if the personality type of the particular pro is very incompatible with the personality type of the client, the Personality perimeter of the particular row may be allotted a low number of points, such as 1 point.

In some embodiments, the Objective parameter for a particular pro is calculated based on a weighted sum of a Personal Interaction parameter and a Report Based parameter. In some embodiments, the weighting of the summed Personal Interaction and Report Based parameters is equal. In alternative embodiments, the weighting of the summed Personal Interaction and Report Based parameters is not equal.

The Personal Interaction parameter may include characteristics of the particular candidate pro related to personal interactions with clients. For example, work habits, such as noise, language, cleanliness, communication with client as measured by the particular candidate pro and/or reports from other clients may be used to determine the Personal Interaction parameter for each particular candidate pro. Other characteristics of the candidate pros related to personal interaction with clients may additionally or alternatively be used.

To determine the Personal Interaction parameter for each candidate pro, a mathematical value corresponding with each characteristic related to personal interactions with clients is calculated. To determine the Personal Interaction parameter for each candidate pro, the mathematical values corresponding with the characteristics related to personal interactions with clients are summed.

In some embodiments, the mathematical values are weighted by coefficients, such that the relative effect on the Personal Interaction parameter for each candidate pro of each of the mathematical values is proportional to or corresponds with the corresponding coefficient. In some embodiments, the coefficients or weighting is standard and is the same for all clients. In some embodiments, the weighting or coefficients corresponding with each of the mathematical values for each particular client is determined based on information from the particular client, where the information from each particular client describes the particular clients desire for or sensitivity to or tolerance of the corresponding characteristic related to personal interactions with pros.

In some embodiments, the Report Based parameter for a particular pro is calculated based on a weighted sum of a Pro Report Based parameter and a Client Report Based parameter. In some embodiments, the weighting of the summed Pro Report Based and Client Report Based parameters is equal. In alternative embodiments, the weighting of the summed Pro Report Based and Client Report Based parameters is not equal. For example, the Pro Report Based parameter may be weighted more than the Client Report Based parameter. For example, the Pro Report Based parameter may be weighted with a 0.7 coefficient and the Client Report Based parameter may be weighted with a 0.3 coefficient.

The Pro Report Based and Client Report Based parameters are based on data related to the pros and to the clients and provide an indication of fit of the pro and the client based on the data, which includes data from previous clients of the pros and from pros previously working with the clients, and may further include desired attributes from the clients and/or the pros.

In some embodiments, one or more aspects of the particular pro determined from previous clients may be weighted according to the desired attributes of the client. For example, if the particular pro is viewed favorably for a first attribute and unfavorably for a second attribute and the first attribute is more important to the client than the second attribute, a first attribute parameter used for calculating the Pro Report Based parameter may be weighted higher than a second attribute parameter.

Similarly, the Client Report Based parameter for the client may be calculated based on reports of the client from pros having previously assisted the client. In some embodiments, the Client Report Based parameter for the client may be calculated based additionally on preferences, or likes and dislikes from the pro. For example, one or more aspects of the reports of the client from pros having previously worked with the client may be weighted according to the likes and dislikes of the pro. For example, if the client is viewed favorably for a first attribute and unfavorably for a second attribute and the first attribute is more important to the pro than the second attribute, a first attribute parameter used for calculating the Client Report Based parameter may be weighted higher than a second attribute parameter.

Other methods may be used to calculate the Pro Report Based and Client Report Based parameters.

As discussed above, the Report Based parameter may be a weighted sum of the Pro Report Based and Client Report Based parameters. In addition, other methods may be used to calculate the Report Based parameter.

Furthermore, as discussed above, the Objective parameter may be a weighted sum of the Personal Interaction parameter and the Report Based parameter. In addition, other methods may be used to calculate the Objective parameter.

As discussed above, the personal characteristic parameter may be a weighted sum of the Personality parameter and the Objective parameter. In addition, other methods may be used to calculate the personal characteristic parameter.

Once the professional and personal characteristic parameters for the candidate pro pros are determined, the process proceeds to block 530 wherein the candidate pros are sorted based on their professional and personal characteristic parameters.

For example, the list of candidate pros may be sorted with a sorting process which first sorts by professional characteristic parameter and then by personal characteristic parameter. Such a sorting process groups candidate pros having professional characteristics of similar or identical value, and sorts the groups by personal characteristics. As a result, of the most professionally compatible pros, the most personally compatible pro may be identified.

Alternatively, the list of candidate pros may be sorted with a sorting process which first sorts by personal characteristic parameter and then by professional characteristic parameter. Such a sorting process groups candidate pros having personal characteristics of similar or identical value, and sorts the groups by professional characteristics. As a result, of the most personally compatible pros, the most professionally compatible pro may be identified.

Once the candidate pros are sorted, the process proceeds to block 540 wherein a candidate pro or next candidate pro is selected based on the sorted list of candidate pros. If a first candidate pro is to be selected, the candidate pro at the top of the sorted list or is most desirable is selected. If a next candidate pro is to be selected, the next candidate pro in the list following the next previously selected candidate pro is selected.

With reference now to FIG. 8, a flowchart illustrating one embodiment of a process 550 which is a more detailed embodiment of block 422 of process 420 illustrated in FIG. 5 wherein the server performing the process 420 selects a pro or a next pro from a set of candidate pros for a client or for a project for a client. In some embodiments, the process 550 can be performed by, for example, one of the servers of the server systems 242, 267.

The process 560 begins at block 560 wherein a pro fit parameter is determined. The pro fit parameter for each particular candidate pro may, for example, be determined based on certain characteristics of the particular candidate pro, for example, stored in any one or more of the databases 400 of the database server 104.

Certain examples of calculating the pro fit parameter based on characteristics of particular candidate pros and client or project desires or requirements are discussed below in more detail.

Characteristics of each particular candidate pro used for determining the pro fit parameter may, for example, include one or more of: a professional characteristic parameter, a project type parameter, a specialty parameter, a personal characteristic parameter, a Personality parameter, an Objective parameter, a Personal Interaction parameter, a Report Based parameter, a Pro Report Based parameter, and a Client Report Based parameter, for example, as these parameters are described elsewhere herein.

For example, the pro fit parameter may be calculated as a sum of a project type parameter, a specialty parameter, a Personality parameter, and an Objective parameter, for example, as these parameters are described elsewhere herein. For example, the pro fit parameter may be calculated with the project type parameter and the specialty parameter having weights of 0.4 and the Personality parameter and the Objective parameter having weights of 0.1. Other weighting schemes may be used.

Additionally or alternatively, characteristics of each particular candidate pro used for determining the professional characteristic parameter may, for example, include location or distance information. For example, the location of an area in which the particular candidate pro is customarily in or a distance from the location of the project to the area may be included. Other location or distance characteristics may additionally or alternatively be used.

In some embodiments, location or distance information associated with each particular pro is used to determine which of the pros may be considered as a candidate pro. For example, if the distance information indicates that a particular pro is too far from the project, the particular pro may be excluded from the list of candidate pros.

Once the pro fit parameter is calculated, the process proceeds to block 580 wherein a candidate pro or next candidate pro is selected based on the pro fit parameter. If a first candidate pro is to be selected, the candidate pro with the most desirable pro fit parameter is selected. If a next candidate pro is to be selected, the candidate pro having the most desirable pro fit parameter of the previously unselected candidate pros is selected.

As discussed herein, of pros or pro types include any type of pro familiar to those of skill in the art. The pro types attributes are stored in a memory accessible to the server system performing the method steps discussed herein. For example, the attributes may be stored using a process discussed with reference to FIG. 6.

As discussed herein, projects or project types include any type of project familiar to those of skill in the art. The project types attributes are stored in a memory accessible to the server system performing the method steps discussed herein. For example, the attributes may be stored using a process discussed with reference to FIG. 6.

As discussed here, specialties of the candidate pros include any specialty familiar to those of skill in the art. The specialty attributes are stored in a memory accessible to the server system performing the method steps discussed herein. For example, the attributes may be stored using a process discussed with reference to FIG. 6.

As discussed here, attributes of reports for pros include any type of report attribute familiar to those of skill in the art. The report attributes are stored in a memory accessible to the server system performing the method steps discussed herein. For example, the attributes may be stored using a process discussed with reference to FIG. 6.

As discussed here, attribute of reports for clients include any type of report attribute to those of skill in the art. The report attributes are stored in a memory accessible to the server system performing the method steps discussed herein. For example, the attributes may be stored using a process discussed with reference to FIG. 6.

As discussed here, preferences, or likes and dislikes from the pros include any type of preferences familiar to those of skill in the art. The preferences, or like and dislike attributes are stored in a memory accessible to the server system performing the method steps discussed herein. For example, the attributes may be stored using a process discussed with reference to FIG. 6.

As discussed here, preferences, or likes and dislikes from the clients include any type of preferences familiar to those of skill in the art. The preferences, or like and dislike attributes are stored in a memory accessible to the server system performing the method steps discussed herein. For example, the attributes may be stored using a process discussed with reference to FIG. 6.

As discussed here, styles include any style familiar to those of skill in the art. The style attributes are stored in a memory accessible to the server system performing the method steps discussed herein. For example, the attributes may be stored using a process discussed with reference to FIG. 6.

Though the present invention is disclosed by way of specific embodiments as described above, those embodiments are not intended to limit the present invention. Based on the methods and the technical aspects disclosed above, variations and changes may be made to the presented embodiments by those skilled in the art without departing from the spirit and the scope of the present invention.

What is claimed is:

1. A system for generating a selection alert, the system comprising:
a client user device comprising:
a wireless communications interface configured to communicate through a cellular network or through Wi-Fi;
an input element configured to allow the client user to input information into the client user device; and
an output element configured to provide the client user with information from the client user device;
a pro user device comprising:
a wireless communications interface configured to communicate through a cellular network or through Wi-Fi;
an input element configured to allow the pro user to input information into the pro user device; and
an output element configured to provide the pro user with information from the pro user device; and
a server configured to:
receive an input identifying a client user;
retrieve information related to a project for the client based on the input;
retrieve information related to a plurality of pro users based on the project information;
select one of the pro users from a pro user database, wherein the selection is based both on a professional characteristic parameter of the pro user and on a personal characteristic parameter of the pro user;
generate a selection alert indicating the selection of the pro user; and
send the selection alert to the client user device from the server.

2. The system of claim 1, wherein the plurality of pro users have capabilities corresponding with the project.

3. The system of claim 1, wherein the server is configured to calculate the professional characteristic parameter based on at least one of: capabilities of the pro user, charge of the pro user, and an expected of completion of the project for the pro user.

4. The system of claim 3, wherein the server is configured to calculate the professional characteristic parameter based on one or more areas of specialty of the pro user.

5. The system of claim 3, wherein the server is configured to calculate the professional characteristic parameter based on location or distance information of the pro user.

6. The system of claim 3, wherein the server is configured to calculate the professional characteristic parameter based on one or more preferences of the client user.

7. The system of claim 1, wherein the server is configured to calculate the personal characteristic parameter based on a result of a personality test.

8. The system of claim 1, wherein the server is configured to calculate the personal characteristic parameter based on a characterization of the pro user as reported by other clients of the pro user.

9. The system of claim 8, wherein the server is configured to calculate the personal characteristic parameter based on weighted aspects of the characterization, wherein the weighting of the aspects is determined based on preferences of the client user.

10. The system of claim 1, wherein the server is configured to calculate the personal characteristic parameter based on a characterization of the client user as reported by other pros used by of the client user.

11. The system of claim 10, wherein the server is configured to calculate the personal characteristic parameter based on weighted aspects of the characterization, wherein the weighting of the aspects is determined based on preferences of the pro user.

12. The system of claim 1, wherein the server is configured to sort the pro users using a process which sorts first by the professional characteristic parameter and then sorts by the personal characteristic parameter.

13. The system of claim 12, wherein the server is configured to select the one pro user based on its position in the sorted pro users.

14. A method of generating a selection alert, the method comprising:
receiving an input identifying a client user at a server;
retrieving information related to a project for the client based on the input;
retrieving information related to a plurality of pro users based on the project information;
selecting one of the pro users from a pro user database, wherein the selection is based both on a professional characteristic parameter of the pro user and on a personal characteristic parameter of the pro user;
generating a selection alert indicating the selection of the pro user; and
sending the selection alert to the client user device from the server.

15. The method of claim 14, further comprising calculating the professional characteristic parameter based on at least one of: capabilities of the pro user, charge of the pro user, and an expected of completion of the project for the pro user.

16. The method of claim 15, further comprising calculating the professional characteristic parameter based on at least one of: an area of specialty of the pro user, location or distance information of the pro user, and one or more preferences of the client user.

17. The method of claim 14, further comprising calculating the personal characteristic parameter based on at least one of: a characterization of the pro user as reported by other clients of the pro user, and a plurality of weighted aspects of the characterization, wherein the weighting of the aspects is determined based on preferences of the client user.

18. The method of claim 14, further comprising calculating the personal characteristic parameter based on at least one of: a characterization of the client user as reported by other pros used by the client user, and a plurality of weighted aspects of the characterization, wherein the weighting of the aspects is determined based on preferences of the pro user.

19. The method of claim 14, further comprising sorting the pro users using a process which sorts first by the professional characteristic parameter and then sorts by the personal characteristic parameter.

20. The method of claim 14, further comprising selecting the one pro user based on its position in the sorted pro users.
